(19) United States
(12) Patent Application Publication
(10) Pub. No.: US 2023/0267394 A1
(43) Pub. Date: Aug. 24, 2023

(54) CENTRALIZED PLANNING AND ANALYTICS SYSTEM FOR GREENHOUSE GROWING OF HYDROPONIC GREENS

(71) Applicant: BRIGHTFARMS, INC., Irvington, NY (US)

(72) Inventors: Kunal DESAI, Princeton Junction, NJ (US); Steve CAMPIONE, South Orange, NJ (US); Nikki FERNANDEZ, Nutley, NJ (US); Zelun SUN, Hoboken, NJ (US); Dominick Mack, Yardley, PA (US)

(73) Assignee: BRIGHTFARMS, INC., Irvington, NY (US)

(21) Appl. No.: 18/167,635

(22) Filed: Feb. 10, 2023

Related U.S. Application Data
(60) Provisional application No. 63/308,536, filed on Feb. 10, 2022.

(51) Int. Cl. G06Q 10/0631; G06Q 10/04; G06Q 10/087; G06Q 30/0601; G06Q 50/02; A01G 31/00; G06T 7/00

(52) U.S. Cl. CPC G06Q 10/06315; G06Q 10/04; G06Q 10/087; G06Q 30/0605; G06Q 50/02; A01G 31/00; G06T 7/0012; G06T 2207/20081; G06T 2207/30188

(57) ABSTRACT

A system for centralized planning and analytics for greenhouse growing of hydroponic produce, the system comprising: at least one greenhouse; an imaging system; a climate module; a forecasting system; a storage medium; a processor which comprises at least a machine learning algorithm which improves the accuracy and the yield forecast; and a network which provides a communication pathway for information to move between at least two of the group consisting of: the greenhouse, the imaging system, the climate module, the storage medium and the processor; wherein the forecasting system generates crop analytics from the imaging system; generates climate trends from the climate module disposed in each the at least one greenhouse; and uses a machine learning algorithm to determine yield forecast of the hydroponic produce.

### CROSS-REFERENCE TO RELATED APPLICATION

The present application claims priority under 35 U.S.C. § 119 to U.S. Provisional Application Ser. No. 63/308,536, which is herein incorporated by reference.

### BACKGROUND

### 1. Field of the Disclosure

A centralized planning and analytics system which interconnects information and data from remote greenhouses with purchasing and accounting systems to enable the system to improve predictive demand planning to optimized pond maps and reduce water consumption and order fulfillment and cross-supply planning in real-time, while enhancing greenhouse automation and integration of analytics, food safety and maintenance functions.

### 2. Discussion of the Background Art

The manual planning process in greenhouse food production is fragmented. It does not bring all the necessary information together to make a real time, data driven decision on a fast-moving consumer product like produce.

### SUMMARY OF THE DISCLOSURE

The present disclosure provides improvements over conventional manual planning systems by providing predictive demand planning to optimize pond maps and reduce waste; order fulfillment and cross-supply planning; real-time planning; enhanced greenhouse automation; elimination of manual tracking; and integration of analytics, food safety and maintenance functions.

The present disclosure also provides many additional advantages, which shall become apparent as described below.

In one embodiment, the present disclosure provides a system for centralized planning and analytics for greenhouse growing of hydroponic produce, the system comprising:
at least one greenhouse;
a purchasing system;
a forecasting system;
a storage medium;
a processor which comprises:
   (a) receiving digital inputs from the greenhouse forecasting;
   (b) collecting operations data to track seed to ship daily activities from at least one selected from the group consisting of: seeding, harvesting, collecting climate data, logistics and supply chain data, thereby determining what the hydroponic produce was harvested and packed to fulfill daily orders;
   (c) analyzing demand and supply forecasts to show variance and provide detail output on future customer fulfillment;
   (d) optimizing the customer fulfillment by calculating fulfillment based on customer priority; and
   (e) integrating data from connected applications and combines the connected applications data with data collected within the system to provide an overall picture of the business,
a network which provides a communication pathway for information to move between at least two of the group consisting of: the greenhouse, the purchasing system, the accounting system, the forecasting system, the storage medium and the processor.

The purchasing system comprises the steps of:
receiving a purchase order from a customer;
if purchase order is approved, transmitting purchase order to a packaging system, wherein the packaging system performs the following steps:
   review purchases order to determine packaging need by the customer and the associated stock-keeping unit(s) (SKU);
   review previous day's inventory and determine if cross-supply inventory from other greenhouses is required to fulfill the purchase order;
   add previous day's inventory to the current day's packaging plan;
   review current day's harvest order and identify if the hydroponic produce will be harvested in real time;
      determine required cases for packaging of the purchase order;
calculate the number of the cases that can be fulfilled based upon the previous day's inventory and the cross-supply inventory;
   if there is not sufficient inventory to fulfill the purchase order, then adjust the number of cases that can be fulfilled and advise the customer of any shortage; and
   if there is sufficient inventory to fulfill the purchase order, then track real time packaging progress until packaging is completed and invoice is generated.

The forecasting system comprises the steps of:
generating crop analytics from an imaging system, wherein the crop analytics comprises provides crop health and growth data (i.e., germination rate and growth rate by crop and microclimate;
generating climate trends from a climate module disposed in each the at least one greenhouse; and
using a machine learning algorithm to determine yield forecast of the hydroponic produce.

The yield forecast is based upon at least one value selected from the group consisting of: ounces of the hydroponic produce per board, board count, and combinations thereof. The yield forecast is converted into pounds per variety of the hydroponic produce.

The system calculates the total supply of the yield forecast against projected demand forecast of the variety of the hydroponic produce.

The forecasting system determines if there is a shortage or excess of any the variety of the hydroponic produce.

If the system determines that there is no shortage or excess of a particular variety of the hydroponic produce, then it creates a seed, transplant, and harvest plan by day, and tracks real-time seed, transplant and harvesting processes.

If the system determines that there is a shortage or excess of a particular variety of the hydroponic produce, then it reforecasts by adjusting a pond map.

If the system determines that the reforecasting by adjusting the pond map solved the excess or shortage issue, then it returns to the step of adding to the yield forecast based upon at least one value selected from the group consisting of: ounces of the hydroponic produce per board, board count, and combinations thereof.

If the system determined that the reforecasting by adjusting the pond map did not solve the excess or shortage issue, then it requests a cross-supply from at least one other greenhouse.

If the cross-supply is accepted by the at least one other greenhouse, then the system adds the cross-supply amount to the inventory of a particular the variety of the hydroponic produce. If the cross-supply is not accepted by the at least one other greenhouse, then the system contacts a customer about the shortage.

The imaging system takes an inventory count of the hydroponic produce transplanted daily, identifies a germination rate, microclimate and the hydroponic produce growth rate throughout the growth cycle, and uses growth analytics to provide an outlook of overall health and potential yield of the hydroponic produce.

The climate module measures climate and pond metrics data regularly in each greenhouse, thereby identifying the client and the pond metrics trends and corresponding yields by variety of the hydroponic produce.

The data from the climate, the pond metrics and the yield are added to the machine learning algorithm which determines the yield forecast based on the data.

The processor and the storage medium perform the following steps: compare against the standard and update the yield forecast accordingly; and store data.

The present disclosure also provides a system for centralized planning and analytics for greenhouse growing of hydroponic produce, the system comprising:
at least one greenhouse;
an imaging system;
a climate module;
a forecasting system;
a storage medium;
a processor which comprises at least a machine learning algorithm which improves the accuracy and the yield forecast; and
a network which provides a communication pathway for information to move between at least two of the group consisting of: the greenhouse, the imaging system, the climate module, the storage medium and the processor.

The forecasting system comprises the steps of:
generating crop analytics from the imaging system;
generating climate trends from the climate module disposed in each the at least one greenhouse; and
using a machine learning algorithm to determine yield forecast of the hydroponic produce.

The yield forecast is based upon at least one value selected from the group consisting of: ounces of the hydroponic produce per board, board count, and combinations thereof. The yield forecast is converted into pounds per variety of the hydroponic produce. The system calculates the total supply of the yield forecast against projected demand forecast of the variety of the hydroponic produce. The forecasting system determines if there is a shortage or excess of any the variety of the hydroponic produce.

If the system determines that there is no shortage or excess of a particular the variety of the hydroponic produce, then it creates a seed, transplant, and harvest plan by day, and tracks real-time seed, transplant and harvesting processes.

If the system determines that there is a shortage or excess of a particular the variety of the hydroponic produce, then it reforecasts by adjusting a pond map.

If the system determines that the reforecasting by adjusting the pond map solved the excess or shortage issue, then it returns to the step of adding to the yield forecast based upon at least one value selected from the group consisting of: ounces of the hydroponic produce per board, board count, and combinations thereof.

If the system determines that the reforecasting by adjusting the pond map did not solve the excess or shortage issue, then it requests a cross-supply from at least one other greenhouse.

If the cross-supply is accepted by the at least one other greenhouse, the system adds the cross-supply amount to the inventory of a particular the variety of the hydroponic produce.

If the cross-supply is not accepted by the at least one other greenhouse, then the system contacts a customer about the shortage.

The imaging system takes an inventory count of the hydroponic produce transplanted daily, identifies a germination rate, microclimate and the hydroponic produce growth rate throughout the growth cycle, and uses growth analytics to provide an outlook of overall health and potential yield of the hydroponic produce.

The climate module measures climate and pond metrics data regularly in each greenhouse, thereby identifying the client and the pond metrics trends and corresponding yields by variety of the hydroponic produce.

The data from the climate, the pond metrics and the yield are added to the machine learning algorithm which determines the yield forecast based on the data.

A system for centralized planning and analytics for greenhouse growing of hydroponic produce, the system comprising:
at least one greenhouse;
a seeding system;
a germination system;
a growing system;
a harvesting system;
a logistics system;
an ordering and packaging system;
a storage medium;
a processor which comprises collecting harvested lbs. information and converts the harvested lbs. into projected SKUs available to be packed based on the SKU recipe and customer priority; and
a network which provides a communication pathway for information to move between at least two of the group consisting of: the greenhouse, the seeding system, the germination system, the growing system, the harvesting system, the logistics system, the ordering and packaging system, the storage medium and the processor.

The seeding system comprises at least one board, seeds, and media, deposits a predetermined amount of the media onto the board such that a plurality of furrows are formed within the media, and thereafter deposits the seeds within the furrows to form a seeded board.

The germination system transfers the seeded board to a germination room for a period of time to enable germination of the seeds disposed thereon.

The growing system determines how many germinated seeds disposed on the seeded board are to be transplanted onto a pond, wherein the growing system also determines the amount of fertilizer, the amount of carbon dioxide and/or adjustments to temperatures required to meet predetermined growth targets, whereby the hydroponic produce is grown on each the seeded board.

The harvest system calculates a daily harvest plan for the hydroponic produce based on purchase orders and pulls enough seeded boards to meet the daily harvest plan.

The logistics system comprises the steps of:
identifying logistics truck(s) needed for deliver to a customer based on receiving a purchase order;
determining the packaging need by the customer and the associated stock-keeping unit(s) (SKU); and
tracking cross-supply request(s) and approval which is used by the logistics system to schedule and transport the hydroponic produce to the customer.

The packaging system determines the actual amount of the hydroponic produce which is harvested via the harvest system and then calculates that amount of the hydroponic product that can be packed.

The processor and the storage medium perform the following steps: calculate lbs. harvested by crop by pond; use lbs. harvested to calculate cases available to pack by SKU and by customer priority in the algorithm; and interact the processor with stored customer orders to identify packaging fulfillment by customer and SKU.

A system for centralized planning and analytics for greenhouse growing of hydroponic produce, the system comprising:
at least one greenhouse;
an operations system;
a forecasting system;
a storage medium;
a processor which comprises at least a machine learning algorithm process; and
a network which provides a communication pathway for information to move between at least two of the group consisting of: the greenhouse, the operations system, the growing system, the forecasting system, the storage medium and the processor.

The operations system comprises:
a seeding system;
a germination system;
a growing system;
a harvesting system;
a logistics system; and
an ordering and packaging system.

The growing system determines how many germinated seeds disposed on a seeded board are to be transplanted onto a pond, wherein the growing system also determines the amount of fertilizer, the amount of carbon dioxide and/or adjustments to temperatures required to meet predetermined growth targets, whereby the hydroponic produce is grown on each the seeded board.

The forecasting system comprises the forecasting system comprises the steps of:
generating crop analytics from an imaging system, wherein the crop analytics comprise: germination rate; growth rate by crop; and microclimate;
generating climate trends from a climate module disposed in each the at least one greenhouse; and
using a machine learning algorithm to determine yield forecast of the hydroponic produce.

The processor and the storage medium perform the following steps: calculating plant growth related calculations such as fertilization use, climate parameters, and pond metrics; and providing yield forecast and actual output.

The machine learning algorithm performs the following calculations: (determined yield forecast of the hydroponic produce) less (total oz/board by variety), thereby improving the overall fulfillment by matching supply with demand.

A method of centralized planning and analytics for greenhouse growing of hydroponic produce, the method comprising:
receiving a purchase order from a customer;
if purchase order is approved, transmitting purchase order to a packaging system, wherein the packaging system performs the following steps:
   reviewing the purchase order to determine packaging need by the customer and the associated stock-keeping unit(s) (SKU);
   reviewing previous day's inventory and determining if cross-supply inventory from other greenhouses is required to fulfill the purchase order;
   adding previous day's inventory to the current day's packaging plan;
   reviewing current day's harvest order and identifying if the hydroponic produce will be harvested in real time;
   determining the required cases for packaging of the purchase order;
   calculating the number of the cases that can be fulfilled based upon the previous day's inventory and the cross-supply inventory;
   if there is not sufficient inventory to fulfill the purchase order, then adjusting the number of cases that can be fulfilled and advise the customer of any shortage; and
   if there is sufficient inventory to fulfill the purchase order, then tracking real time packaging progress until packaging is completed and invoice is generated.

The forecasting a yield of hydroponic produce comprising the steps of:
generating crop analytics from an imaging system, wherein the crop analytics comprises provides crop health and growth data, germination rate, growth rate by crop, and microclimate;
generating climate trends from a climate module disposed in each the at least one greenhouse; and
using a machine learning algorithm to determine yield forecast of the hydroponic produce.

The yield forecast is based upon at least one value selected from the group consisting of: ounces of the hydroponic produce per board, board count, and combinations thereof. The yield forecast is converted into pounds per variety of the hydroponic produce.

The method further comprising calculating the total supply of the yield forecast against projected demand forecast of the variety of the hydroponic produce.

The forecasting method determines if there is a shortage or excess of any the variety of the hydroponic produce. If the forecasting method determines that there is no shortage or excess of a particular the variety of the hydroponic produce, then it creates a seed, transplant, and harvest plan by day, and tracking real-time seed, transplant and harvesting processes. If the forecasting method determines that there is a shortage or excess of a particular the variety of the hydroponic produce, then it reforecasts by adjusting a pond map.

If the forecasting method determines that the reforecasting by adjusting the pond map solved the excess or shortage issue, then it returns to the step of adding to the yield forecast based upon at least one value selected from the group consisting of: ounces of the hydroponic produce per board, board count, and combinations thereof.

If the forecasting method determines that the reforecasting by adjusting the pond map did not solve the excess or shortage issue, then it requests the cross-supply inventory from at least one other greenhouse.

If the cross-supply inventory is accepted by the at least one other greenhouse, then the system adds the cross-supply inventory amount to the inventory of a particular the variety of the hydroponic produce.

If the cross-supply inventory is not accepted by the at least one other greenhouse, then the system contacts a customer about the shortage.

The imaging system takes an inventory count of the hydroponic produce transplanted daily, identifies a germination rate, microclimate and the hydroponic produce growth rate throughout the growth cycle, and uses growth analytics to provide an outlook of overall health and potential yield of the hydroponic produce.

The climate module measures climate and pond metrics data regularly in each greenhouse, thereby identifying the client and the pond metrics trends and corresponding yields by variety of the hydroponic produce.

The data from the climate, the pond metrics and the yield are added to the machine learning algorithm which determines the yield forecast based on the data.

The method further comprises the following steps: comparing against the standard and updating the yield forecast accordingly; storing the yield and the sales forecast, thereby improving sales and operations planning process.

A method for centralized planning and analytics for greenhouse growing of hydroponic produce, the method comprising:
depositing a predetermined amount of the media onto a board such that a plurality of furrows are formed within the media, and depositing the seeds within the furrows to form a seeded board;
transferring the seeded board to a germination room for a period of time to enable germination of the seeds disposed thereon;
determining how many germinated seeds disposed on the seeded board are to be transplanted onto a pond;
determining the amount of fertilizer, the amount of carbon dioxide and/or adjustments to temperatures required to meet predetermined growth targets, whereby the hydroponic produce is grown on each the seeded board;
calculating a daily harvest plan for the hydroponic produce based on purchase orders and pulling sufficient number of seeded boards to meet the daily harvest plan.

The method further comprises:
identifying the number of logistics truck(s) needed for delivering to a customer based on receiving a purchase order;
determining the packaging need by the customer and the associated stock-keeping unit(s) (SKU); and
tracking cross-supply inventory request(s) and approval which is used by the logistics system to schedule and transport the hydroponic produce to the customer.

The method further comprises: determining the actual amount of the hydroponic produce which is harvested via the harvest system and then calculating the amount of the hydroponic product that can be packed.

A method for centralized planning and analytics for greenhouse growing of hydroponic produce, the method comprising:
determining how many germinated seeds disposed on a seeded board are to be transplanted onto a pond;
determining the amount of fertilizer, the amount of carbon dioxide and/or adjustments to temperatures required to meet predetermined growth targets, whereby the hydroponic produce is grown on each the seeded board;
generating crop analytics from an imaging system, wherein the crop analytics comprise analysis of climate above the crop (i.e., temperature, light level humidity etc.); climate below the crop (i.e., water temperature, pH, DO, etc.); and germination and growth rate;
generating climate trends from a climate module disposed in each the at least one greenhouse; and
using a machine learning algorithm to determine yield forecast of the hydroponic produce.

The machine learning algorithm performs the following calculations: (determined yield forecast of the hydroponic produce) less (total oz/board by variety), thereby improving the overall fulfillment by matching supply with demand.

Further objects, features and advantages of the present disclosure will be understood by reference to the following drawings and detailed description.

### BRIEF DESCRIPTION OF THE DRAWINGS

FIG. 1 is a flow diagram of the seed-to-ship backbone and integration of farm support applications according to the present disclosure;

FIG. 2 is a block diagram of the centralized planning and analytics system according to the present disclosure;

FIG. 3 is a block diagram of the system which integrates imaging technology, greenhouse climate data and microclimate analytics according to the present disclosure;

FIGS. 4a-j are climate data and reports;

FIG. 5 is a block diagram of the seed-to-ship backbone according to the present disclosure;

FIG. 5a is a block diagram of the seeding process of FIG. 5;

FIG. 5b is a block diagram of the germination process of FIG. 5;

FIG. 5c is a block diagram of the growing process of FIG. 5;

FIG. 5d is a block diagram of the harvesting process of FIG. 5;

FIG. 5e describes the packaging process of FIG. 5;

FIG. 5f describes the pre-cool process of FIG. 5;

FIG. 6 is a block diagram of the utilization of forecasting and machine learning systems of the present disclosure used to operate the centralized planning and analytics system according to the present disclosure;

FIGS. 6a-o are production forecast, harvest, and sales charts according to the present disclosure;

FIG. 7 is a logic diagram pertaining to the order fulfillment of the seed-to-ship backbone of FIG. 5, above;

FIG. 8 is a logic diagram pertaining centralized forecasting and analytics of FIG. 6, above; and

FIG. 9 is a logic diagram depicting the artificial intelligence and crop yield forecasting analytics of FIG. 8.

### DETAILED DESCRIPTION OF THE DISCLOSURE

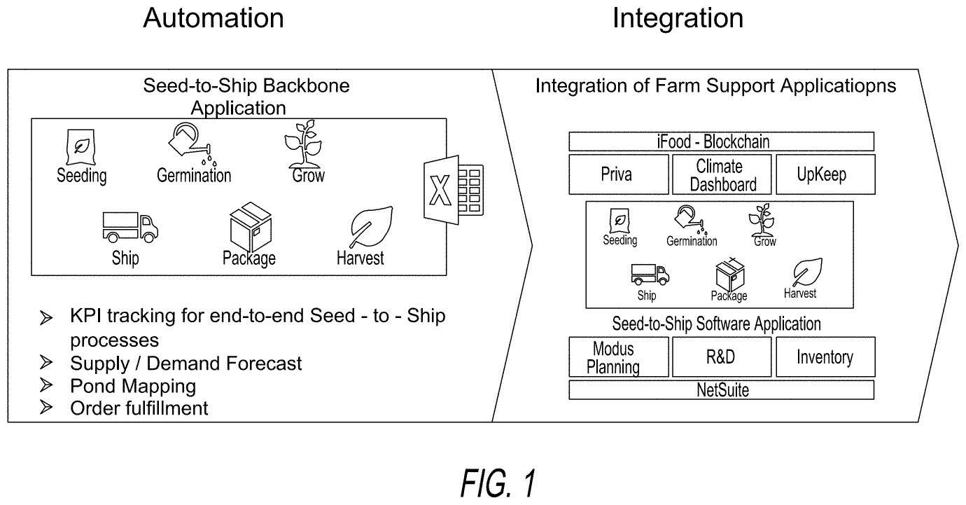

The disclosure is best understood by reference to the figures, wherein FIG. 1 is a flow diagram of the seed-to-ship backbone and integration of farm support applications according to the present disclosure. The seed-to-ship backbone includes, but is not limited to, the steps of seeding, germination, growing, harvesting, packaging, and shipping. KPI (key performance indicator) tracking is used for the end-to-end seed-to-ship process, together with supply/demand forecasts, pond mapping and order fulfillment. A pond is a pool of water, e.g. a water tank or other similar structure, that holds the rafts that are germinated to grow produce. The pond is located in or in close proximity to a greenhouse.

The seed-to-ship backbone involves the integration of various farm support applications, i.e., Priva™, climate dashboard, CMMS, Modus™ Planning, and Inventory (e.g., NetSuite).

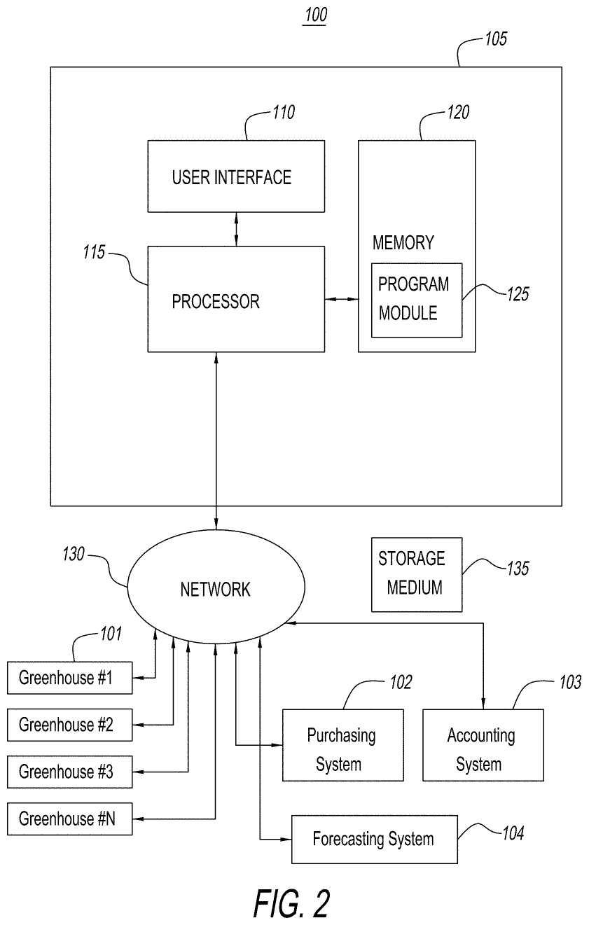

FIG. 2 is a block diagram of the centralized planning and analytics system according to the present disclosure. It shows a system for centralized planning and analytics for greenhouse growing of hydroponic produce, the system comprising: at least one greenhouse 101; a purchasing system 102; an accounting system 103; a forecasting system 104; a storage medium 135; a processor 115 which comprises operations and supply demand planning algorithms; and a network 130 which provides a communication pathway for information to move between at least two of the group consisting of: the greenhouse 101, the purchasing system 102, the accounting system 103, the forecasting system 104, the storage medium 135 and the processor 115.

Furthermore, FIG. 2 depicts a system 100, for employment of the present disclosure. System 100 includes a computer 105 coupled to a network 130, e.g., the Internet.

Computer 105 includes a user interface 110, a processor 115, and a memory 120. Computer 105 may be implemented on a general-purpose microcomputer. Although computer 105 is represented herein as a standalone device, it is not limited to such, but instead can be coupled to other devices (not shown) via network 130.

Processor 115 is configured of logic circuitry that responds to and executes instructions.

Memory 120 stores data and instructions for controlling the operation of processor 115. Memory 120 may be implemented in a random access memory (RAM), a hard drive, a read only memory (ROM), or a combination thereof. One of the components of memory 120 is a program module 125.

Program module 125 contains instructions for controlling processor 115 to execute the methods described herein. For example, as a result of execution of program module 125, processor 115 executes a method of centralized planning and analytics for greenhouse growing of hydroponic produce, the method comprising:
receiving a purchase order from a customer;
if the purchase order is approved, transmitting the purchase order to a packaging system, wherein the packaging system performs the following steps:
   reviewing the purchase order to determine packaging need by the customer and the associated stock-keeping unit(s) (SKU);
   reviewing a previous day's inventory and determining if cross-supply inventory from other greenhouses is required to fulfill the purchase order;
   adding the previous day's inventory to the current day's packaging plan;
   reviewing the current day's harvest order and identifying if the hydroponic produce will be harvested in real time;
   determining the required cases for packaging of the purchase order;
   calculating the number of the cases that can be fulfilled based upon the previous day's inventory and the cross-supply inventory;
   if there is not sufficient inventory to fulfill the purchase order, then adjusting the number of cases that can be fulfilled and advise the customer of any shortage; and
   if there is sufficient inventory to fulfill the purchase order, then tracking real time packaging progress until packaging is completed and invoice is generated.

The processor further forecasts a yield of hydroponic produce by:
generating crop analytics from an imaging system, wherein the crop analytics comprises provides crop health and growth data, germination rate, growth rate by crop, and microclimate;
generating climate trends from a climate module disposed in each the at least one greenhouse; and
using a machine learning algorithm to determine yield forecast of the hydroponic produce.

The yield forecast is based upon at least one value selected from the group consisting of: ounces of the hydroponic produce per board, board count, and combinations thereof. The yield forecast is converted into pounds per variety of the hydroponic produce.

The processor further calculates the total supply of the yield forecast against projected demand forecast of the variety of the hydroponic produce.

The forecasting method determines if there is a shortage or excess of any the variety of the hydroponic produce. The forecasting method determines that there is no shortage or excess of a particular the variety of the hydroponic produce, then creating seed, transplant, and harvest plan by day, and tracking real-time seed, transplant and harvesting processes.

If the forecasting method determines that there is a shortage or excess of a particular the variety of the hydroponic produce, then reforecasting is completed by adjusting a pond map.

If the forecasting method determines that the reforecasting by adjusting the pond map solved the excess or shortage issue, then the system returns to the step of adding to the yield forecast based upon at least one value selected from the group consisting of: ounces of the hydroponic produce per board, board count, and combinations thereof.

If the forecasting method determines that the reforecasting by adjusting the pond map did not solve the excess or shortage issue, then requesting the cross-supply inventory from at least one other greenhouse can be done.

If the cross-supply inventory is accepted by the at least one other greenhouse, then adding the cross-supply inventory amount to the inventory of a particular the variety of the hydroponic produce can be done.

If the cross-supply inventory is not accepted by the at least one other greenhouse, then the system contacts a customer about the shortage.

The imaging system takes an inventory count of the hydroponic produce transplanted daily, identifies a germination rate, microclimate and the hydroponic produce growth rate throughout the growth cycle, and uses growth analytics to provide an outlook of overall health and potential yield of the hydroponic produce.

The climate module measures climate and pond metrics data regularly is each the greenhouse, thereby identifying the client and the pond metrics trends and corresponding yields by variety of the hydroponic produce.

The data from the climate module, the pond metrics and the yield are added to the machine learning algorithm which determines the yield forecast based on the data.

The processor further executes the following steps: comparing against the standard and updating the yield forecast accordingly; storing the yield and the sales forecast, thereby improving sales and operations planning process.

The processor optionally executes a method for centralized planning and analytics for greenhouse growing of hydroponic produce, the method comprising:
depositing a predetermined amount of the media onto a board such that a plurality of furrows are formed within the media, and depositing the seeds within the furrows to form a seeded board;
transferring the seeded board to a germination room for a period of time to enable germination of the seeds disposed thereon;
determining how many germinated seeds disposed on the seeded board are to be transplanted onto a pond;
determining the amount of fertilizer, the amount of carbon dioxide and/or adjustments to temperatures required to meet predetermined growth targets, whereby the hydroponic produce is grown on each the seeded board; and
calculating a daily harvest plan for the hydroponic produce based on purchase orders and pulling sufficient number of seeded boards to meet the daily harvest plan.

The method may also further comprise:
identifying the number of logistics truck(s) needed for delivering to a customer based on receiving a purchase order;
determining the packaging need by the customer and the associated stock-keeping unit(s) (SKU); and
tracking cross-supply inventory request(s) and approval which is used by the logistics system to schedule and transport the hydroponic produce to the customer.

The method may also further comprise:
determining the actual amount of the hydroponic produce which is harvested via the harvest system and then calculating the amount of the hydroponic product that can be packed.

The process according to another embodiment executes a method for centralized planning and analytics for greenhouse growing of hydroponic produce, the method comprising:
determining how many germinated seeds disposed on a seeded board are to be transplanted onto a pond;
determining the amount of fertilizer, the amount of carbon dioxide and/or adjustments to temperatures required to meet predetermined growth targets, whereby the hydroponic produce is grown on each the seeded board;
generating crop analytics from an imaging system, wherein the crop analytics comprise analysis of climate above the crop (i.e., temperature, light level humidity etc.); climate below the crop (i.e., water temperature, pH, DO, etc.); and germination and growth rate;
generating climate trends from a climate module disposed in each the at least one greenhouse; and
using a machine learning algorithm to determine yield forecast of the hydroponic produce.

The processor utilizes a machine learning algorithm to perform the following calculations (determined yield forecast of the hydroponic produce) less (total oz/board by variety), thereby improving the overall fulfillment by matching supply with demand.

The term “module” is used herein to denote a functional operation that may be embodied either as a stand-alone component or as an integrated configuration of a plurality of sub-ordinate components. Thus, program module 125 may be implemented as a single module or as a plurality of modules that operate in cooperation with one another. Moreover, although program module 125 is described herein as being installed in memory 120, and therefore being implemented in software, it could be implemented in any of hardware (e.g., electronic circuitry), firmware, software, or a combination thereof.

User interface 110 includes an input device, such as a keyboard or speech recognition subsystem, for enabling a user to communicate information and command selections to processor 115. User interface 110 also includes an output device such as a display or a printer. A cursor control such as a mouse, trackball, or joystick, allows the user to manipulate a cursor on the display for communicating additional information and command selections to processor 115.

Processor 115 outputs, to user interface 110, a result of an execution of the methods described herein. Alternatively, processor 115 could direct the output to a remote device (not shown) via network 130.

While program module 125 is indicated as already loaded into memory 120, it may be configured on a storage medium 135 for subsequent loading into memory 120. Storage medium 135 can be any conventional storage medium that stores program module 125 thereon in tangible form. Examples of storage medium 135 include a floppy disk, a compact disk, a magnetic tape, a read only memory, an optical storage media, universal serial bus (USB) flash drive, a digital versatile disc, or a zip drive. Alternatively, storage medium 135 can be a random access memory, or other type of electronic storage, located on a remote storage system and coupled to computer 105 via network 130.

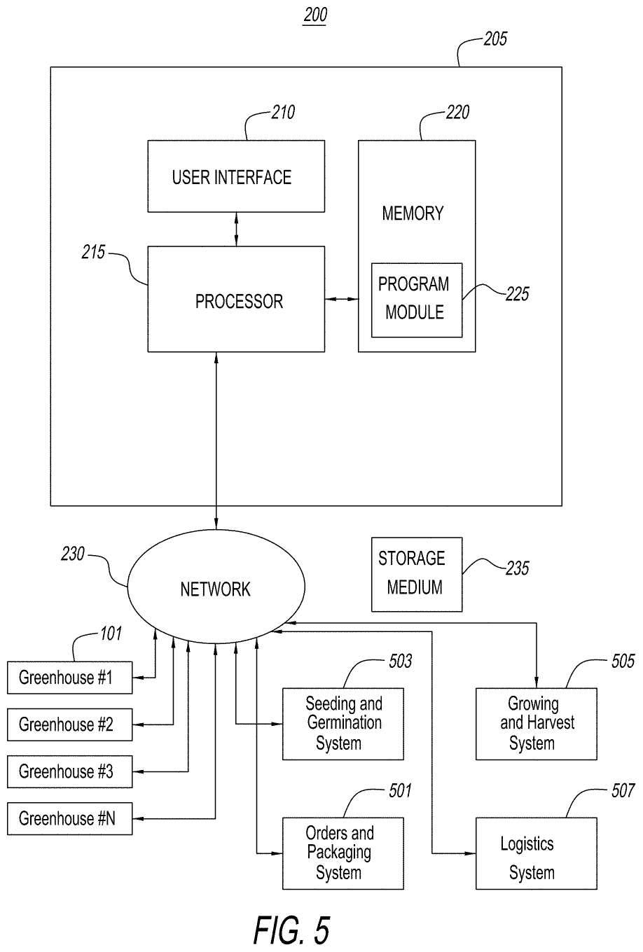

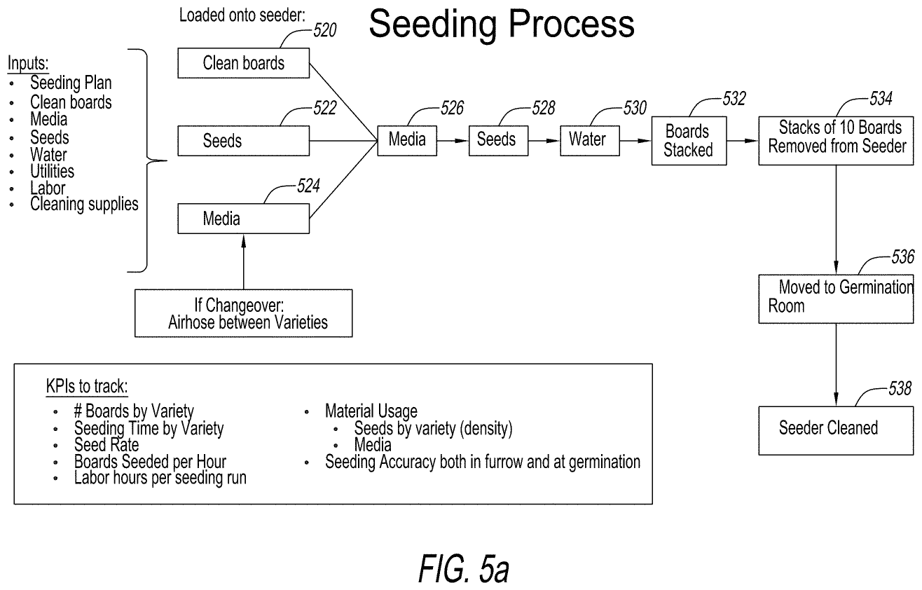

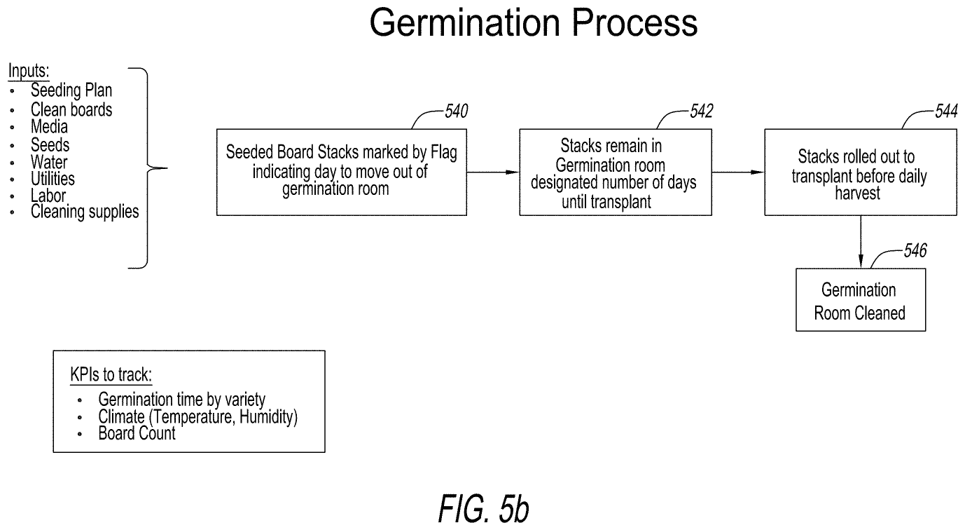

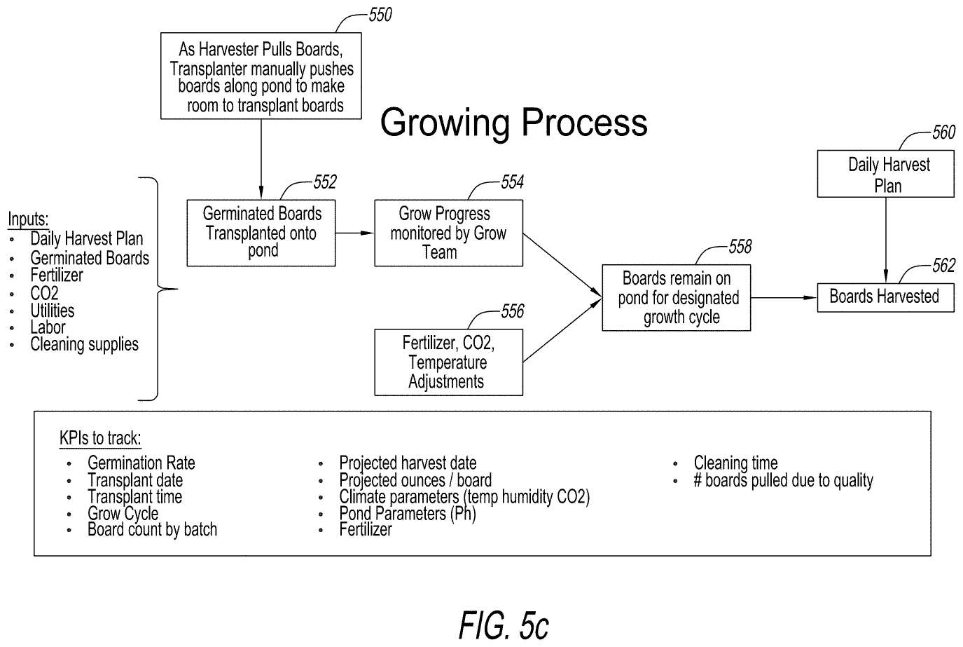

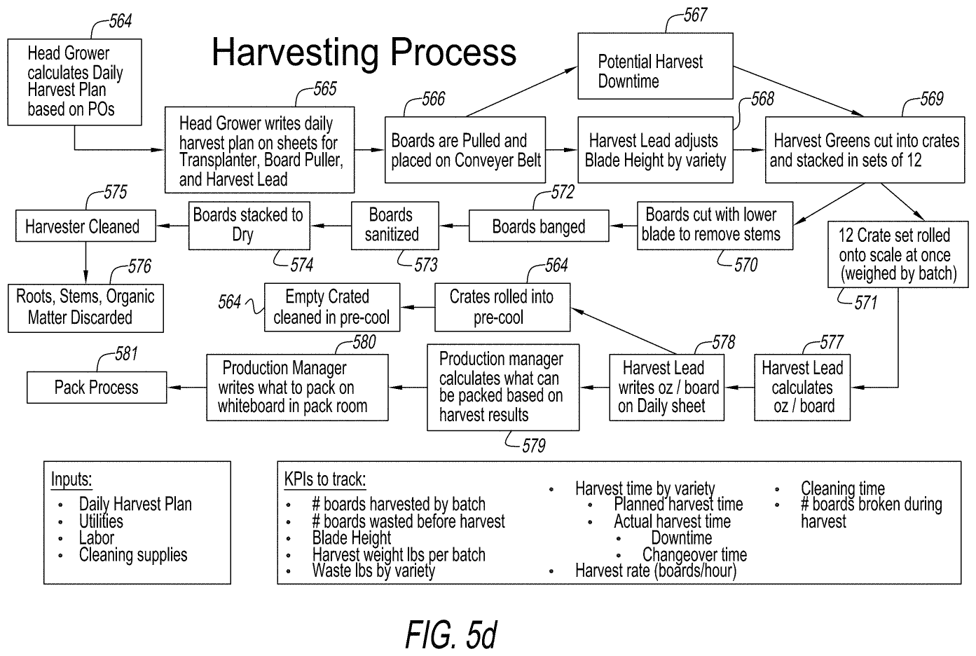

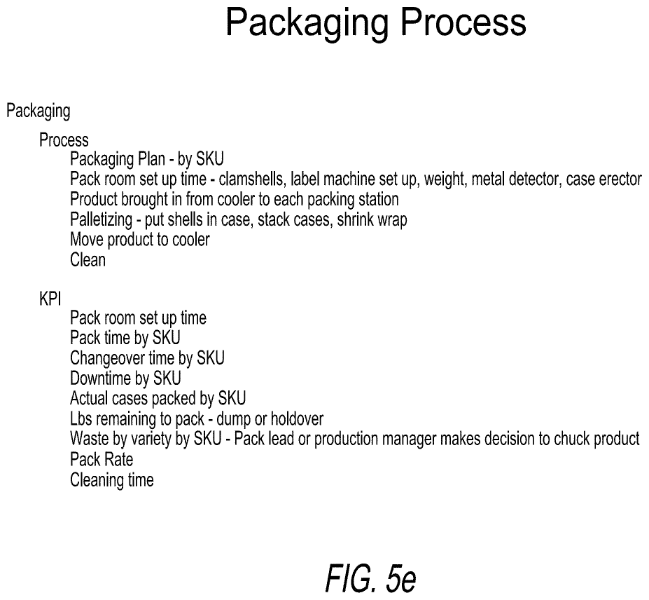

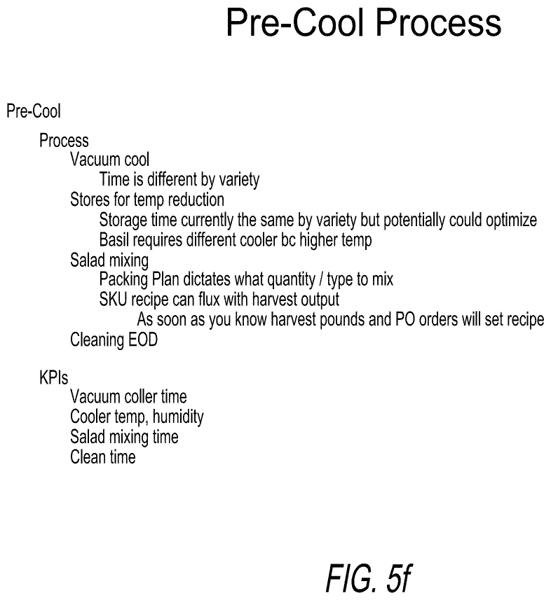

The purchasing system 102 comprises the steps of: receiving a purchase order from a customer; if the purchase order is approved, transmitting the purchase order to a packaging system (see FIG. 5), wherein the packaging system 501 performs the following steps: review the purchase order to determine order fulfillment; review previous day's inventory and determine if cross-supply inventory from other greenhouses is required to fulfill the purchase order; add previous day's inventory to the current day's packaging plan; review current day's harvest order and identify if the hydroponic produce will be harvested in real time; determine required cases for packaging of the purchase order; calculate the number of the cases that can be fulfilled based upon the previous day's inventory and the cross-supply inventory; if there is not sufficient inventory to fulfill the purchase order, then adjust the number of cases that can be fulfilled and advise the customer of any shortage; and if there is sufficient inventory to fulfill the purchase order, then track real time packaging progress until packaging is completed and invoice is generated.

The accounting system 103 comprises NetSuite ERP.

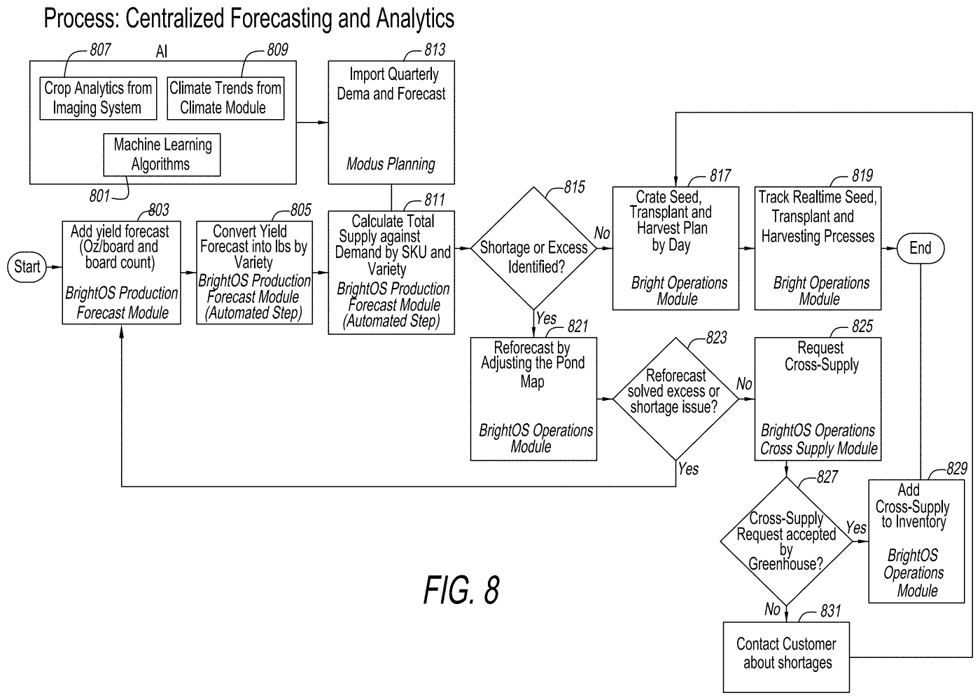

Forecasting system 104 in FIG. 1 is further explained in the logic flow diagram of FIG. 8 which comprises the steps of: generating crop analytics from an imaging system 807; generating climate trends from a climate module 809 disposed in each the at least one greenhouse; and using a machine learning algorithm 801 to determine yield forecast 803 of the hydroponic produce. Yield forecast 803 is based upon at least one value selected from the group consisting of: ounces of the hydroponic produce per board, board count, and combinations thereof. Yield forecast 803 is converted 805 into pounds per variety of the hydroponic produce. The system calculates the total supply 811 of the yield forecast against projected demand forecast 813 of the variety of the hydroponic produce. The forecasting system 104 determines if there is a shortage or excess 815 of any particular the variety of the hydroponic produce.

If forecasting system 104 determines that there is no shortage or excess 815 of a particular the variety of the hydroponic produce, then it creates a seed, transplant, and harvest plan by day 817, and tracks real-time seed, transplant and harvesting processes 819.

If, however, the forecasting system 104 determines that there is a shortage or excess 815 of a particular variety of the hydroponic produce, then it reforecasts by adjusting a pond map 821.

If the forecasting system 104 determines that the reforecasting by adjusting the pond map solved the excess or shortage issue 823, then it returns to step 803 of adding to the yield forecast based upon at least one value selected from the group consisting of: ounces of the hydroponic produce per board, board count, and combinations thereof.

If, however, the forecasting system 104 determines that the reforecasting by adjusting the pond map 823 did not solve the excess or shortage issue, then it will request a cross-supply 825 from at least one other greenhouse 101. If the cross-supply is accepted 827 by the at least one other greenhouse 101, then the cross-supply amount is added to the inventory 829 of a particular variety of the hydroponic produce. If, however, the cross-supply 827 is not accepted by the at least one other greenhouse 101, then the customer is contacted 831, in advance, about the shortage.

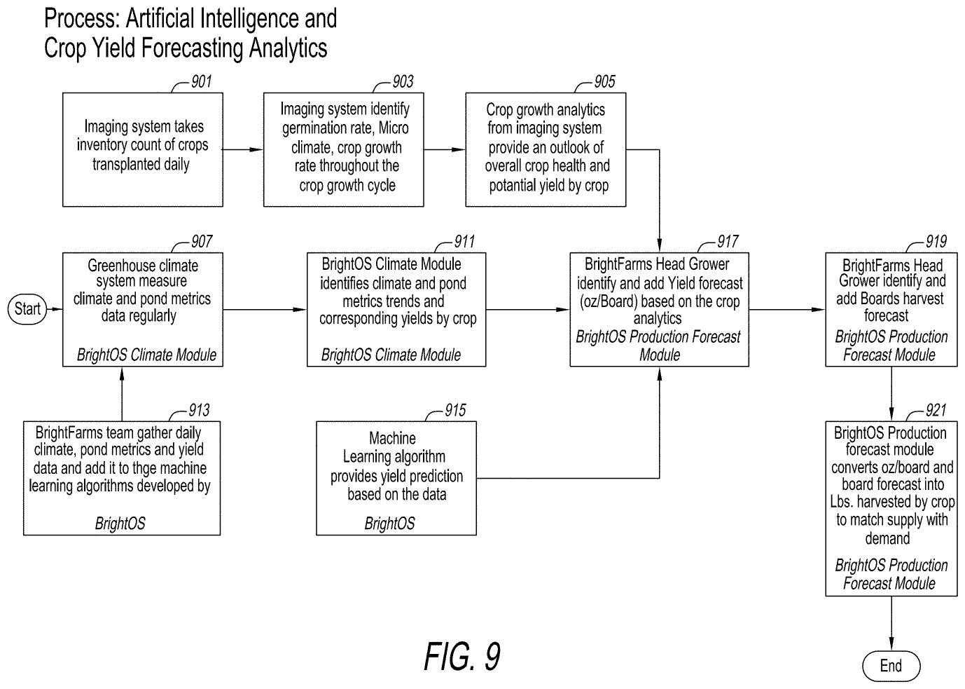

FIG. 9 shows a logic diagram depicting the artificial intelligence using machine learning algorithms 801 on crop analytics 807 generated from imaging system 201 and climate trends 809 from climate module 202 of FIG. 8.

Imaging system 201 takes an inventory count of the hydroponic produce transplanted daily 901, identifies a germination rate, microclimate, and the hydroponic produce growth rate throughout the growth cycle 903, and uses growth analytics to provide an outlook of overall health and potential yield of the hydroponic produce 905.

Climate module 202 measures climate and pond metrics data regularly 907 in each the greenhouse 101, thereby identifying the client and the pond metrics trends and corresponding yields by variety of the hydroponic produce 911.

The data from the climate, the pond metrics, and the yield 913 are added to the machine learning algorithm 801 which determines the yield forecast 803 based on the data 915.

Thereafter, the head grower identifies and adds yield forecast (oz/Board) 917 based on crop growth analytics 807,905, climate and pond metrics trends 809,911 and yield prediction 803,915 generated by machine learning algorithm 801,915. The head grower identifies and add Boards harvest forecast 919. Forecast module 104 then converts oz/board and board forecast into lbs. harvested by crop to match supply with demand 805, 811, 813, 921.

Processor 115 and storage medium 135 in FIG. 2 perform the following steps: stores production and forecast data to process at different stages of the platform.

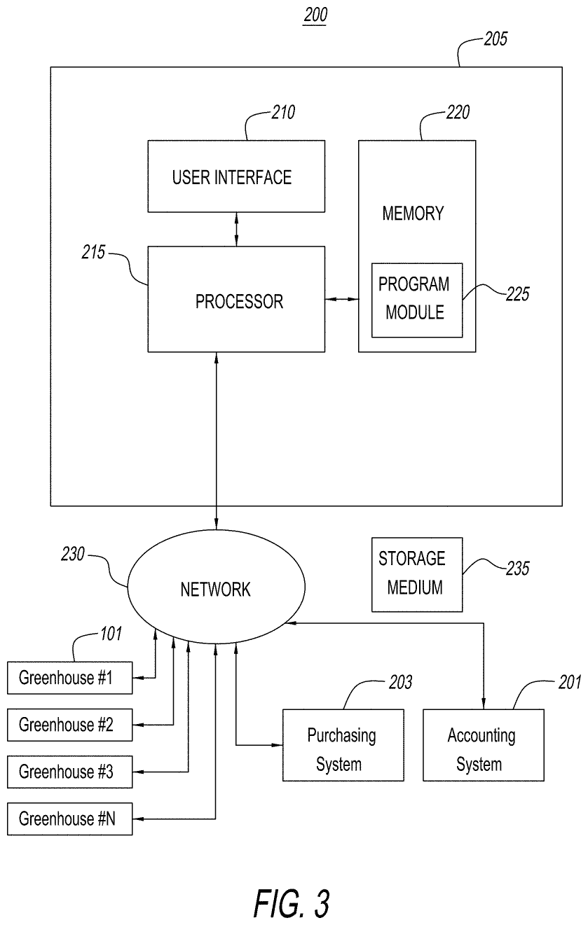

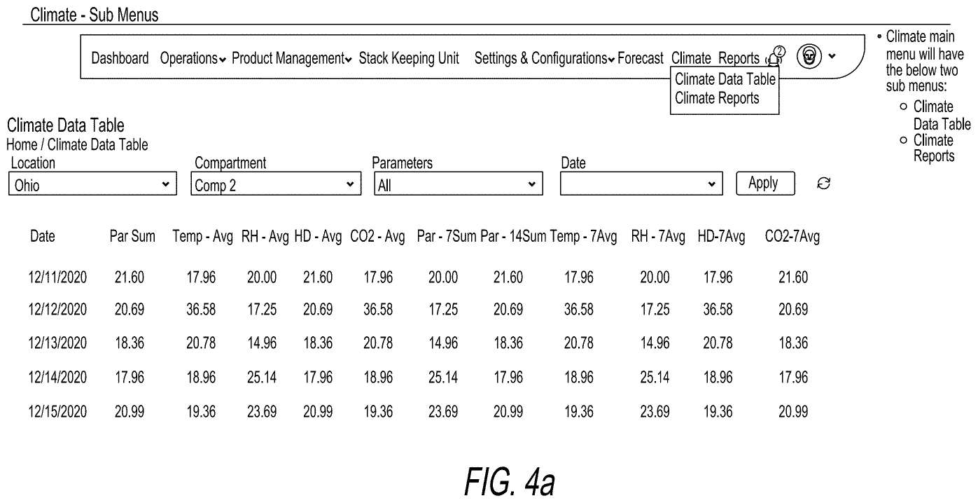

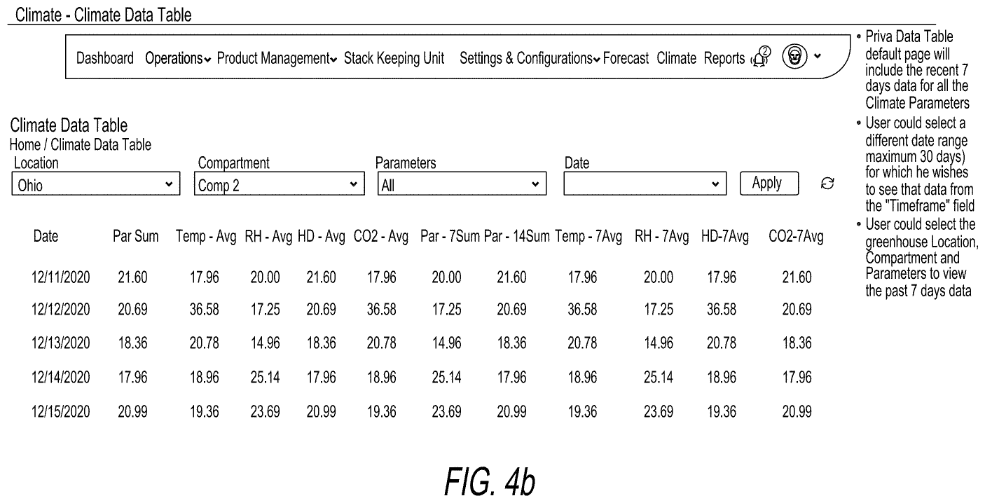

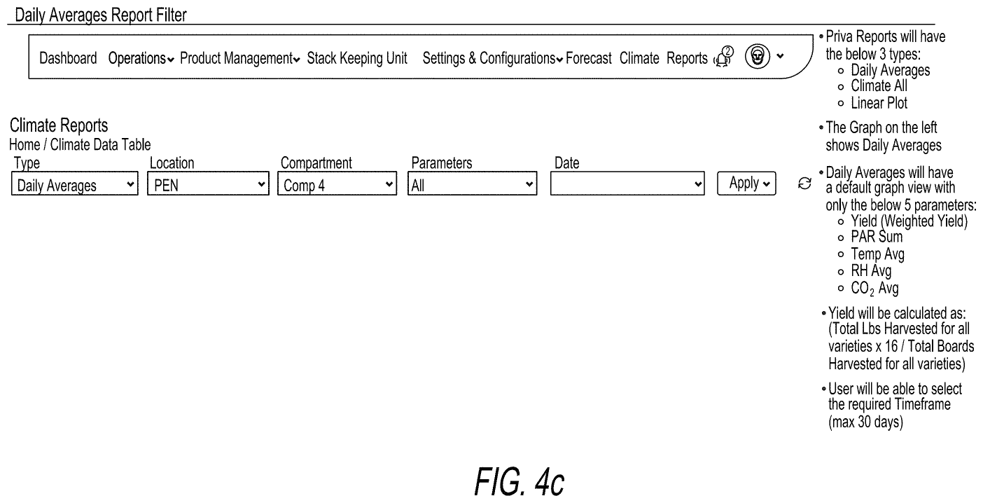

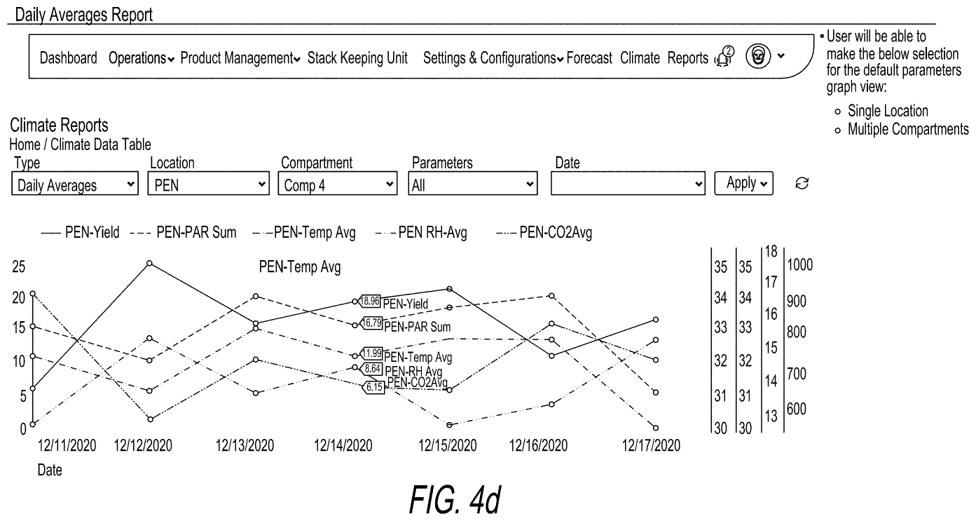

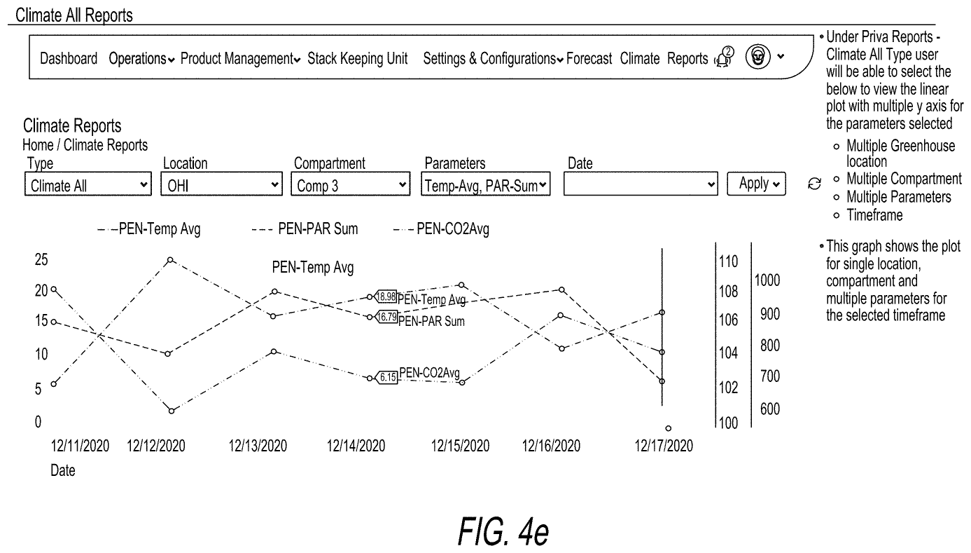

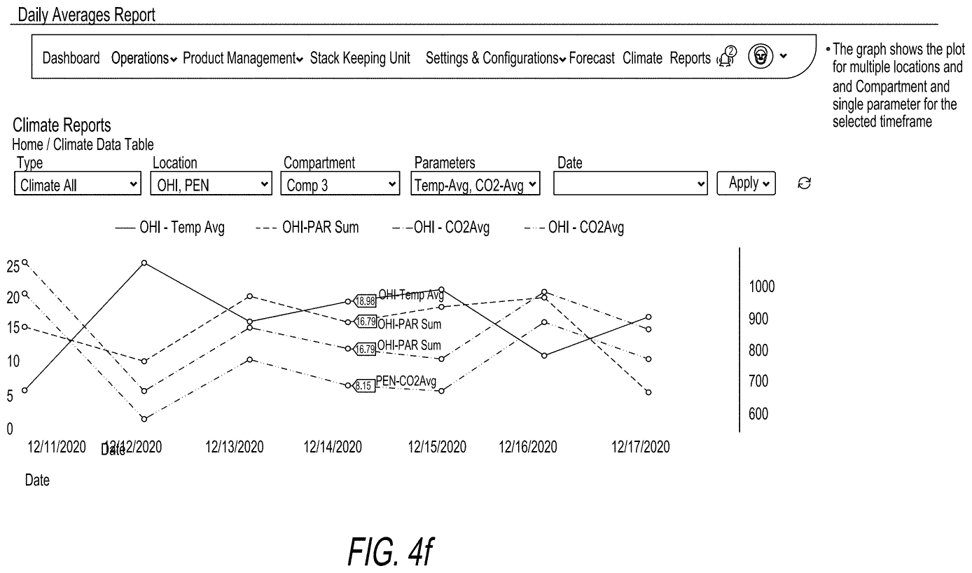

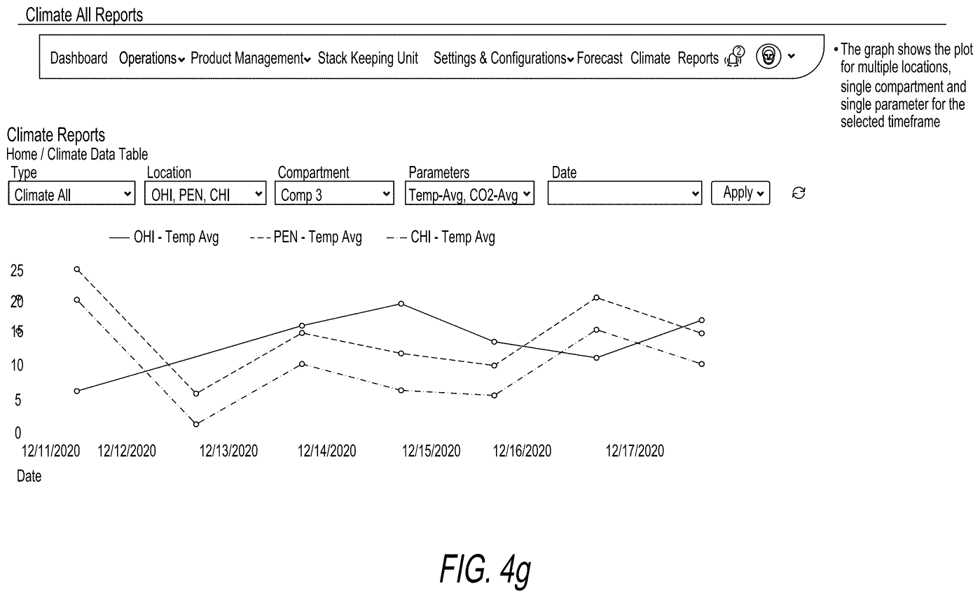

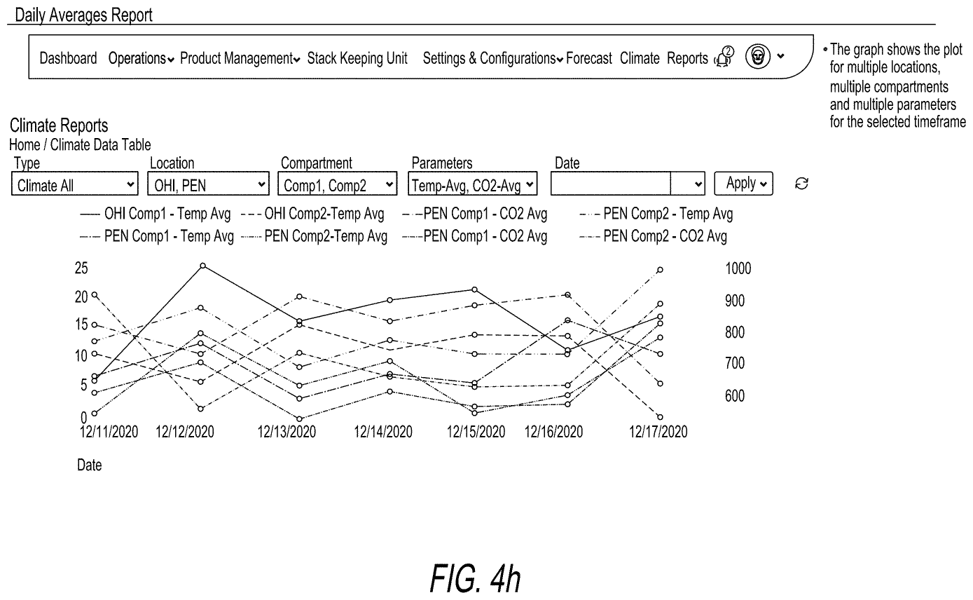

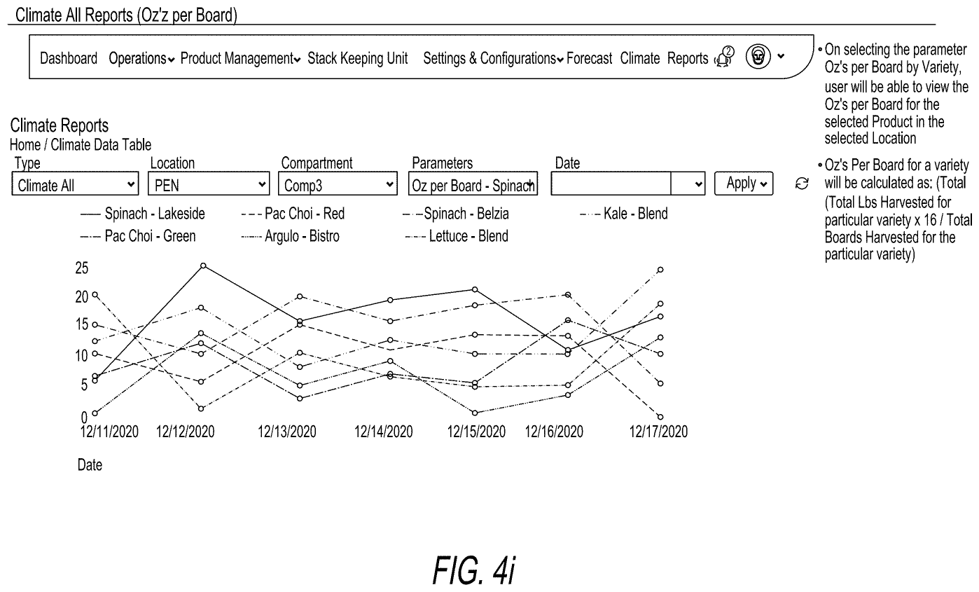

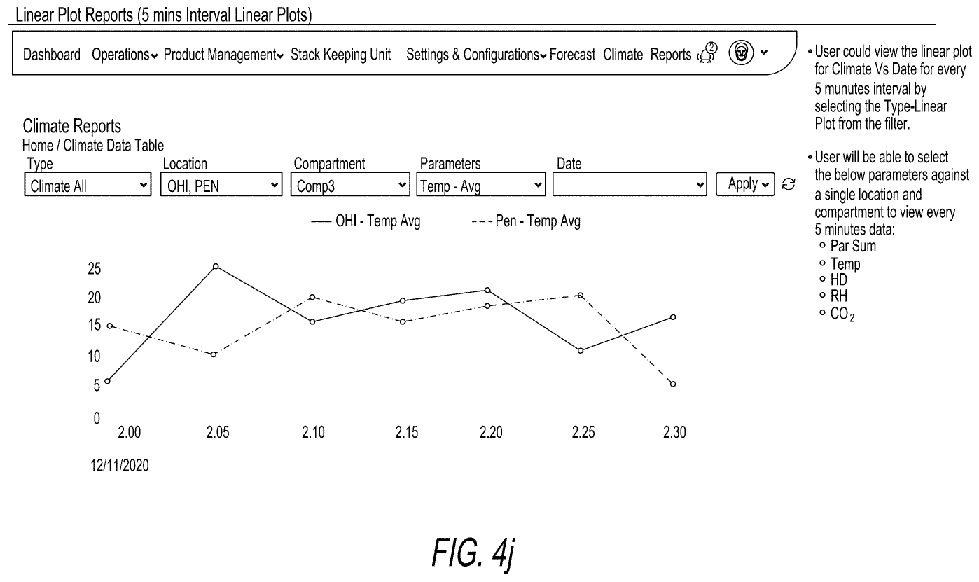

FIG. 3 is a block diagram of the system 200 which integrates imaging technology 201, greenhouse climate data and microclimate analytics 203 according to the present disclosure. FIGS. 4a-b disclose sample climate data generated by microclimate analytics 203. The climate module provides different variables in a greenhouse that affects the yield. Climate module information is used to improve yield prediction modeling.

FIGS. 4c-j disclose climate reports generated by microclimate analytics 203. Climate reports provide climate variable trends to the growers. This helps them identify a variable that is out of spec that could impact yield.

FIG. 5 is a block diagram of the seed-to-ship backbone according to the present disclosure comprising a seeding and germination systems 503, growing and harvesting system 505, orders and packaging systems 501, and logistics systems 507.

FIG. 5a is a block diagram of the seeding process of FIG. 5, wherein the start of the seeding process begins with clean boards 520, seeds 522 and media 524. Thereafter, media 524 is laid on clean boards 520 in step 526, followed by step 528 wherein seeds 522 are placed in media 524, and then watered in step 530. Boards which have been processed via steps 526, 528 and 530 are thereafter stacked in step 532. Preferably, stacks of 10 boards from step 532 are removed from the seeder device (not shown) in step 534, moved to a germination room in step 536 and the seeder device is cleaned in step 538 to start steps 526 through 536 all over again.

FIG. 5b is a block diagram of the germination process of FIG. 5, wherein the germination process starts with step 540 wherein seeded boards from the seeding process are marked to identify the day to remove them from the germination room, whereas the stacks of seeded boards while be marked to identify the designated number of days until transplant in step 542. Thereafter, the stacks which have been identified to be removed from the germination room on a given day are rolled out to transplant before daily harvest in step 544 and the germination room is cleaned in step 546. The germination process tracks the following key performance indicators (KPI): (a) germination time by variety, (b) climate (i.e., temperature, humidity) and (c) board count.

FIG. 5c is a block diagram of the growing process of FIG. 5, wherein a harvester pulls board while a transplanter manually pushes boards along a pond to make room to transplant boards in step 550. In step 552, the germinated boards are transplanted onto the pond where the growing process is monitored in step 554. Fertilizer, CO₂, and temperature adjustments are then provided germinated boards in step 556 while the germinated boards remain on the pond for a designated growth cycle in step 558. Thereafter, pursuant to a daily harvest plan 560, the germinated board are harvested in step 562. The growing process tracks the following key performance indicators (KPI): (a) germination rate, (b) transplant date, (c) transplant time, (d) grow cycle, (e) board count by batch, (f) projected harvest date, (g) projected ounces/board, (h) climate parameters (temperature, humidity, and CO₂), (i) pond parameters (pH), (j) fertilizer, (k) cleaning time, and (l) number of boards pulled due to quality.

FIG. 5d is a block diagram of the harvesting process of FIG. 5, wherein the process starts in step 564 with a process for calculating the daily harvest plan based on purchase orders. The daily harvest plan is then then distributed to transplanters, board pullers and harvesters in step 565. In step 566, boards having plants or greens that are ready for harvest are pulled and placed on a conveyer belt, steps 567 and 568 either bypass harvest blade height adjuster or adjusts a blade height to harvest greens by variety, respectively. In step 569, the harvest greens are cut into crates and stacked in sets of 12. Thereafter, crated harvested greens are transported onto a scale and weighed by batch in step 571, while the boards are cut with a lower blade to remove any remaining stems in step 570.

Once the stems are cut further in step 570, the boards are banged to remove any remaining organic materials and media disposed therein in step 572, boards are then sanitized in step 573, the boards are stacked to dry in step 574, the harvester is cleaned in step 575, and roots, stems, organic matter (media) are discarded in step 576.

Once crates with greens are weighed in step 571, the green yield (oz/board) is calculated in step 577 and then recorded in step 578. The amount of green yield allows the harvesting process to calculate what can be packed based on harvest results in step 579 and this is record in step 580 before the packing process 581 begins. Empty crates are then rolled into pre-cool in step 582 before the empty crates are cleaned in pre-cool in step 583.

The harvesting process tracks the following key performance indicators (KPI): (a) number of boards harvested by batch, (b) number of boards wasted before harvest, (c) blade height, (d) harvest weight lbs. per batch is calculated, (e) calculate waste lbs. by variety, (f) harvest time by variety, i.e., planned harvest time and actual harvest time (including downtime and changeover time), (g) harvest rate (boards/hour), (h) cleaning time, and (i) number of boards broken during harvest.

FIG. 5e describes the packaging process of FIG. 5, which includes the steps of (a) packaging plan by SKU, (b) pack room set up time for clamshells, label machine set up, weight, metal detector, and case erector, (c) product brought in from cooler to each packing station, (d) palletizing, i.e., put shells in case, stack cases, shrink wrap, (f) move product to cooler, and (g) clean. The packaging process tracks the following key performance indicators (KPI): (a) pack room set up time, (b) pack time by SKU, (c) changeover time by SKU, (d) downtime by SKU, (e) actual cases packed by SKU, (f) lbs. remaining to pack, i.e., dump or holdover, (g) waste by variety by SKU, i.e., pack lead, or production manager makes decision to discard product, (h) pack rate, and (i) cleaning time.

FIG. 5f describes the pre-cool process of FIG. 5, wherein the pre-cool process includes the following steps: (a) vacuum cool wherein the time is different by variety, (b) stores for temperature reduction, i.e., storage time currently the same by variety but potentially could be optimized, and basil required different cooler because higher temperature is required, (c) salad mixing, i.e., packing plan dictates what quantity and type greens to mix, and SKU recipe can fluctuate with harvest output, that is as soon as one knows the harvest pounds and purchase orders the recipe will be set, and (d) cleaning EOD (end of day).

The pre-cool process tracks the following key performance indicators (KPI): (a) vacuum cooler time, cooler temperature and humidity, salad mixing time and clean time.

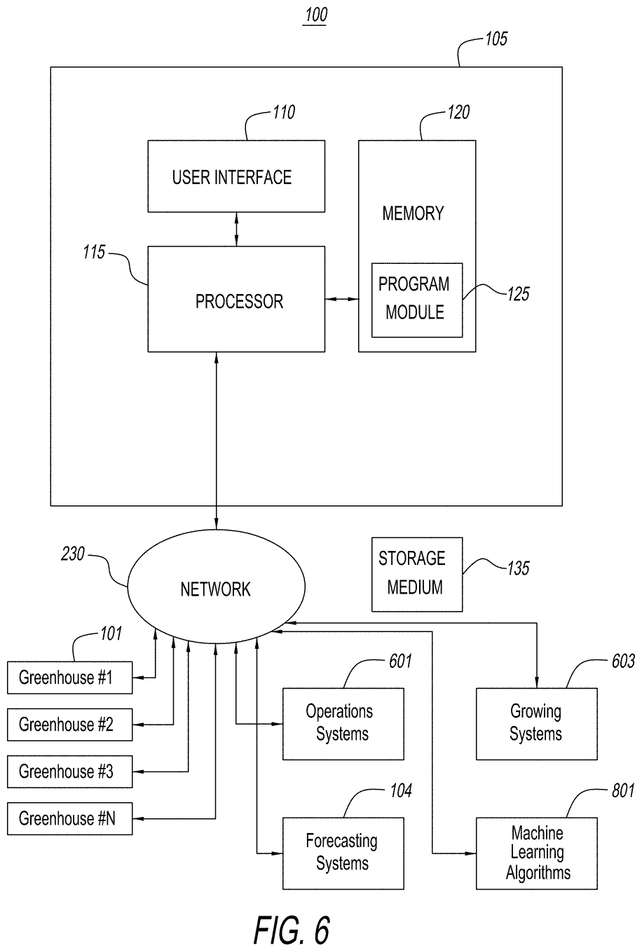

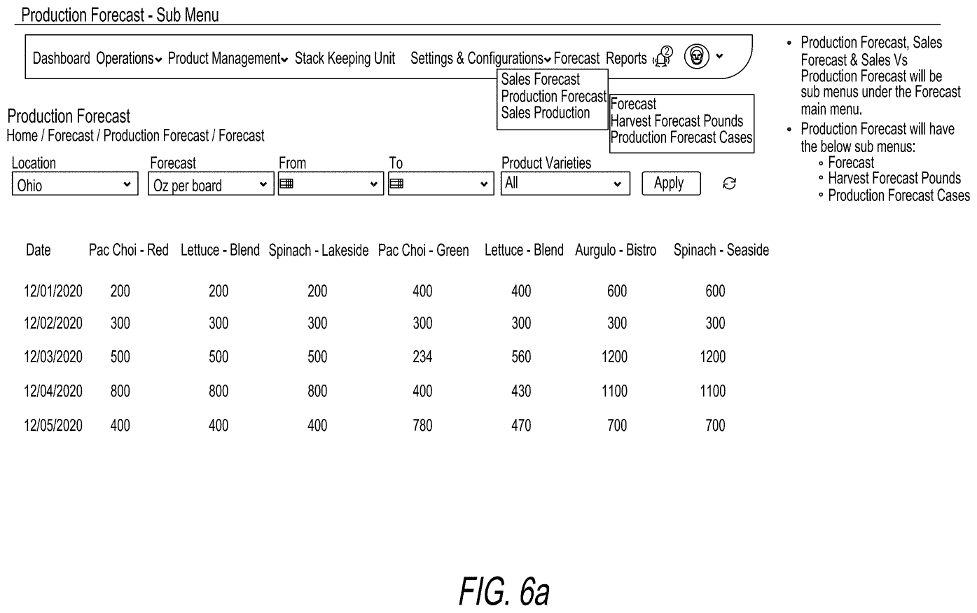

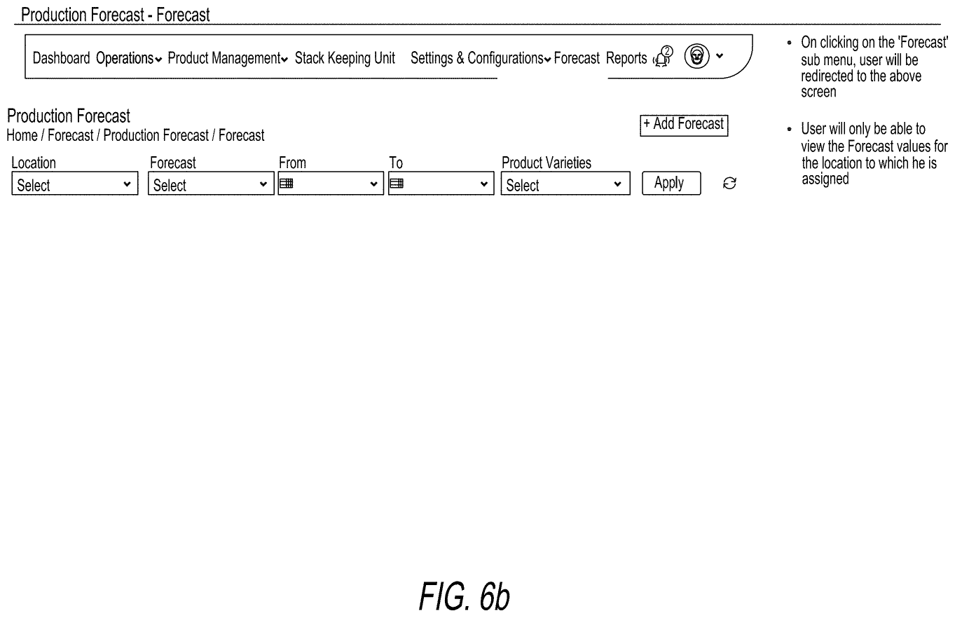

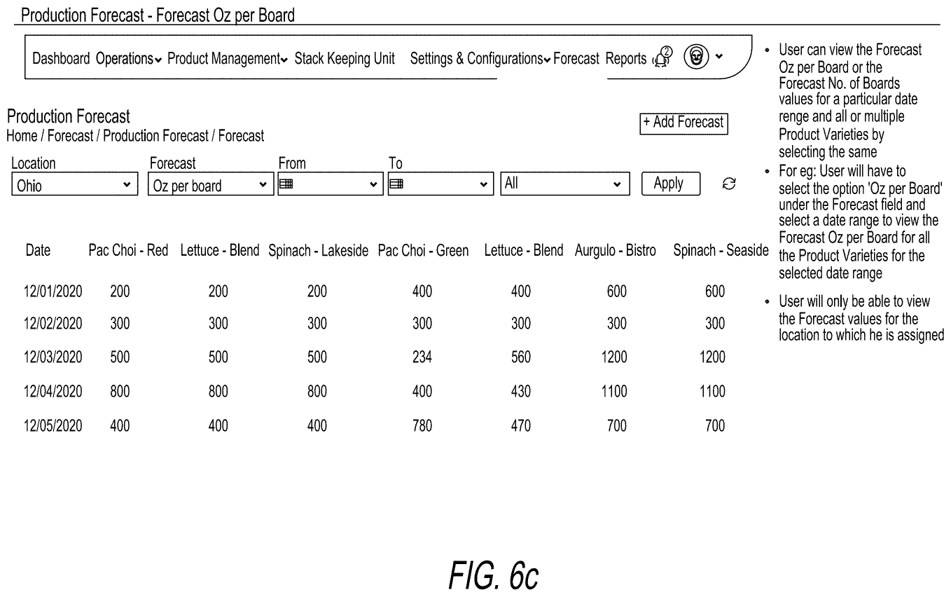

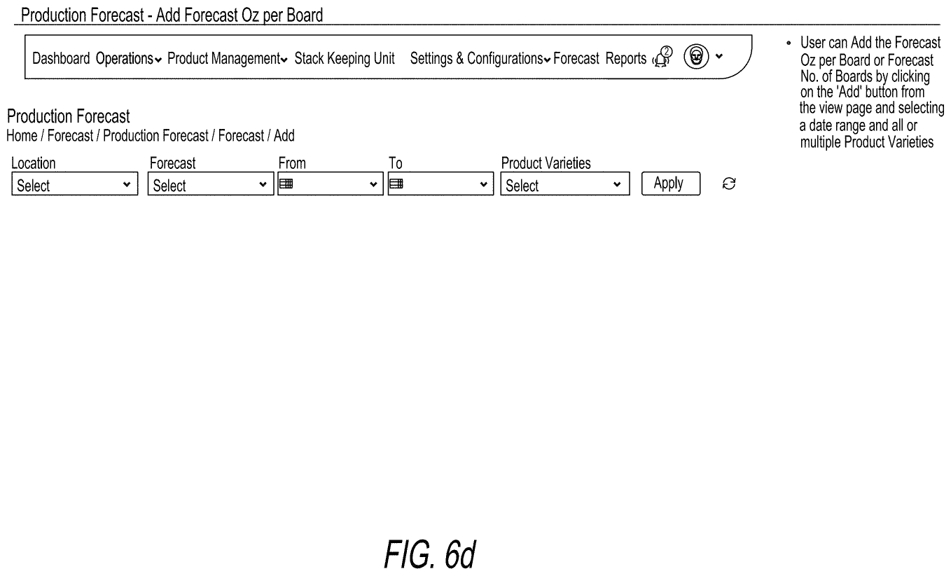

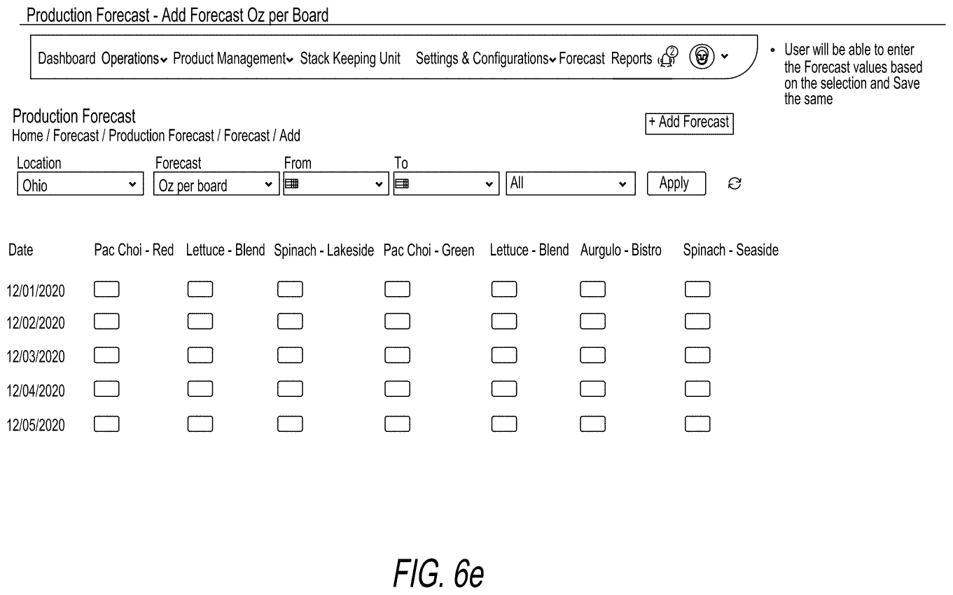

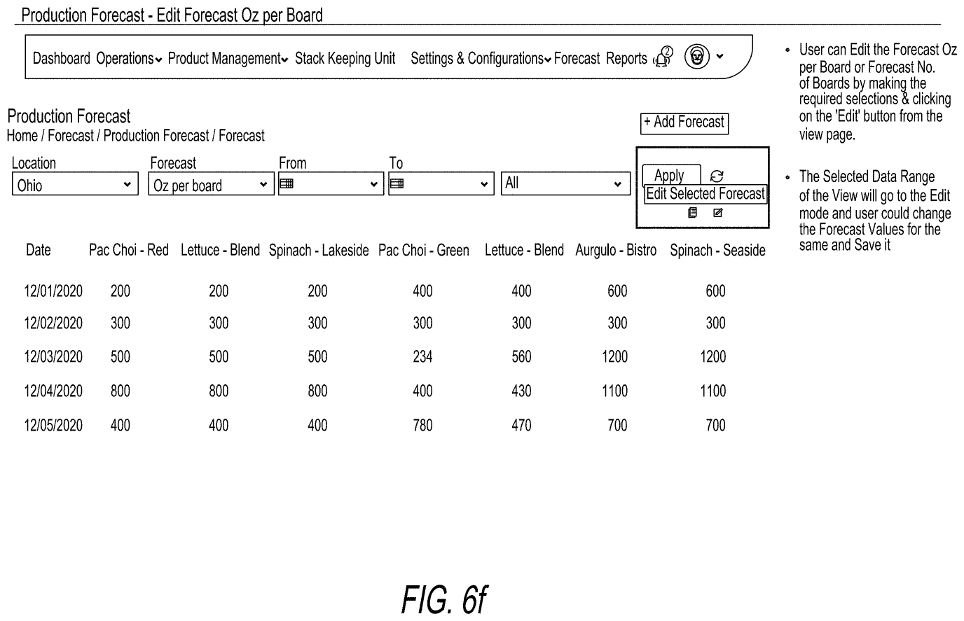

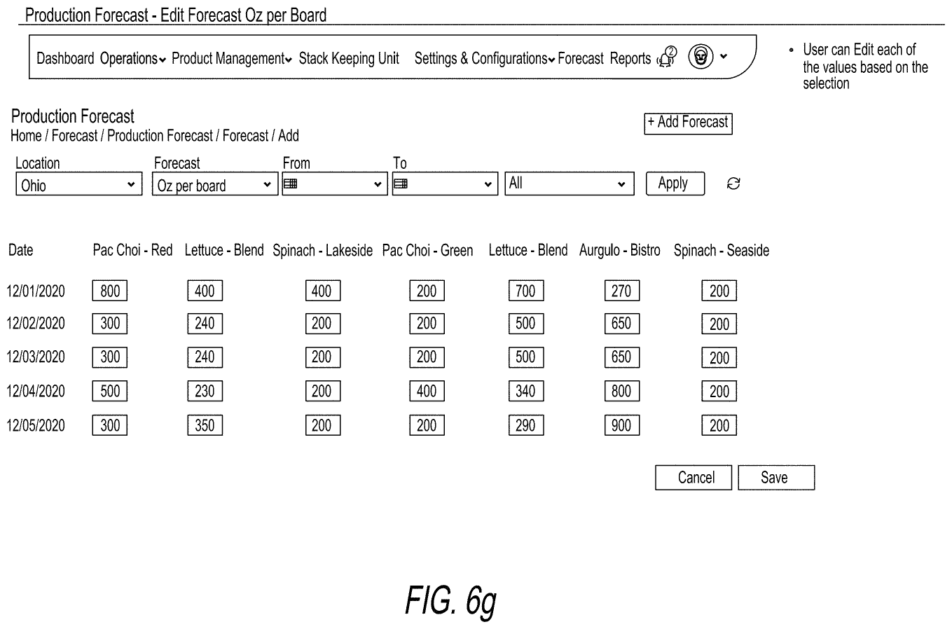

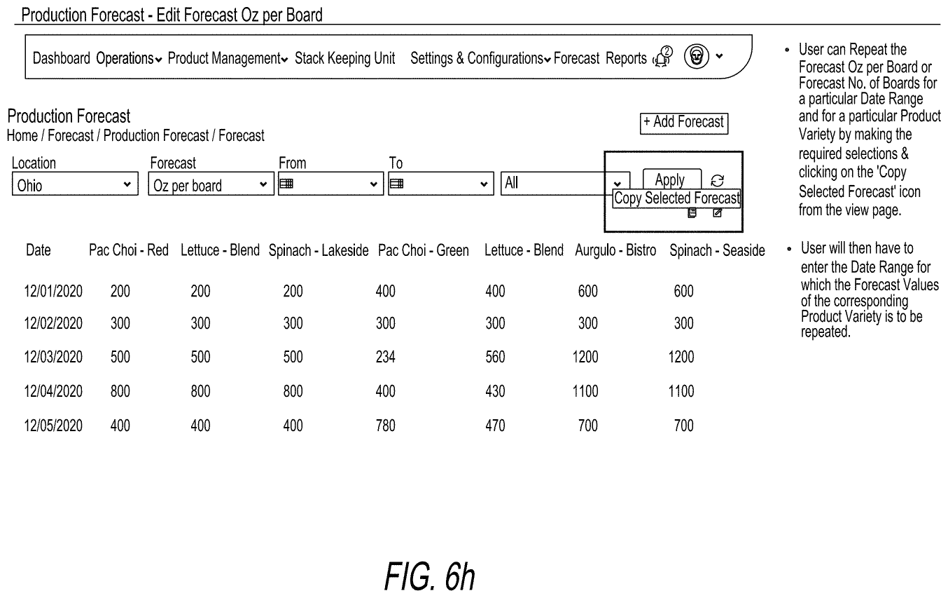

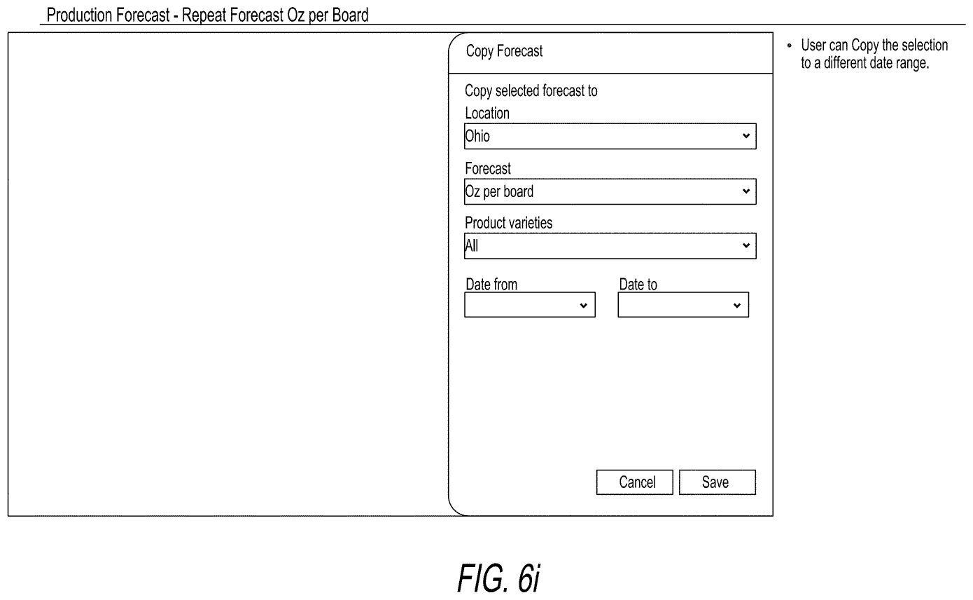

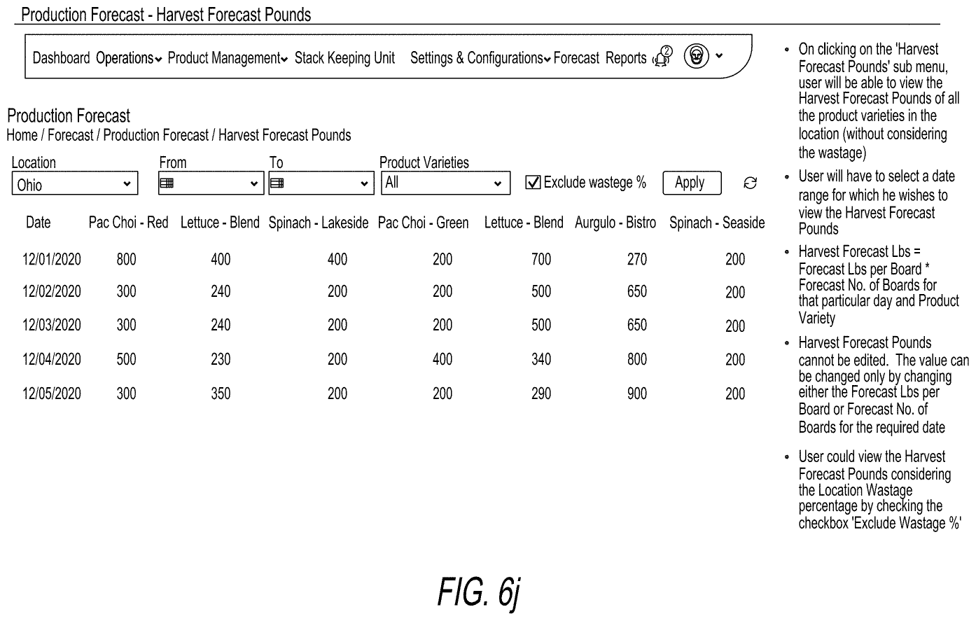

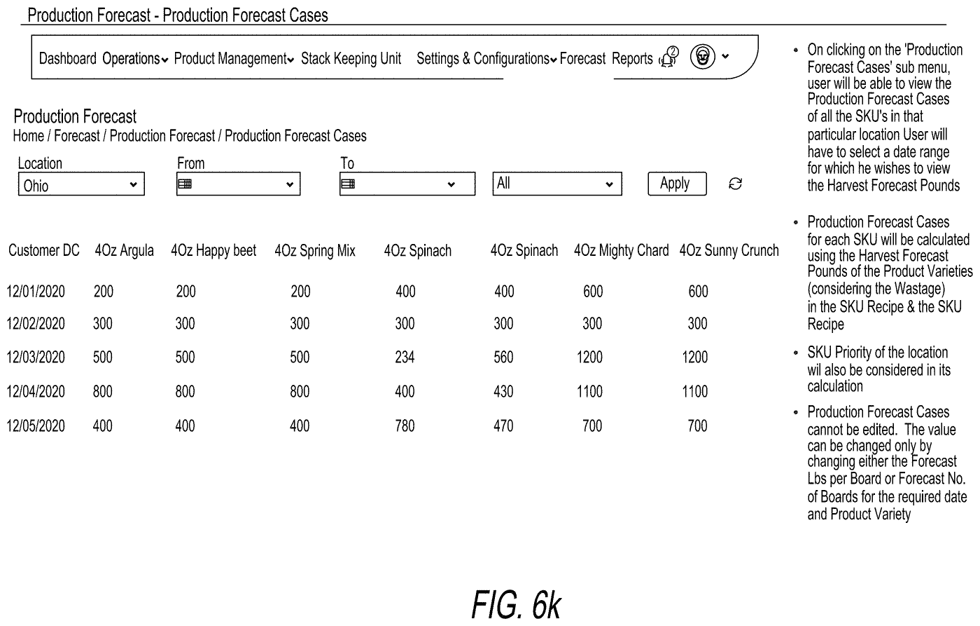

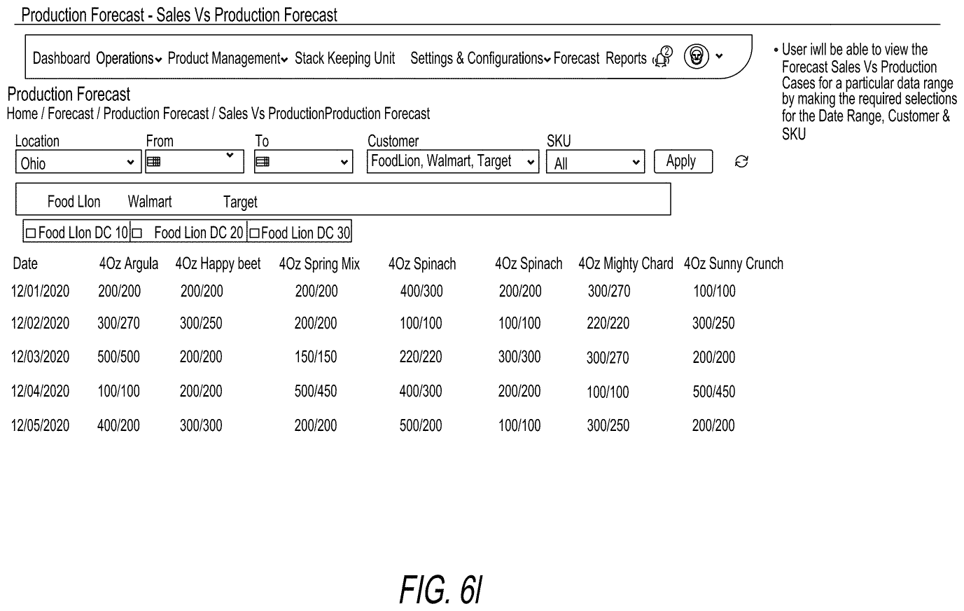

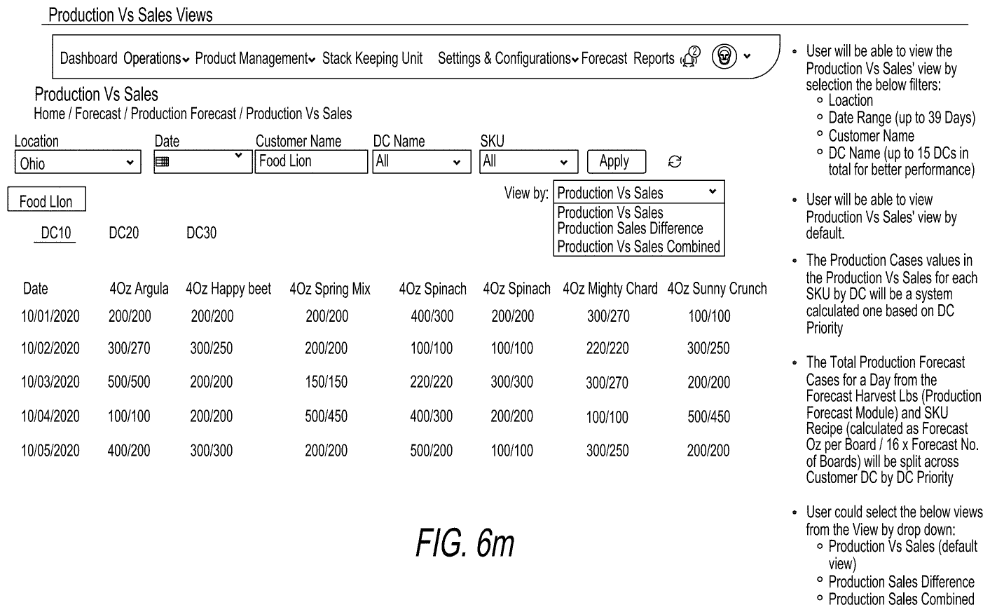

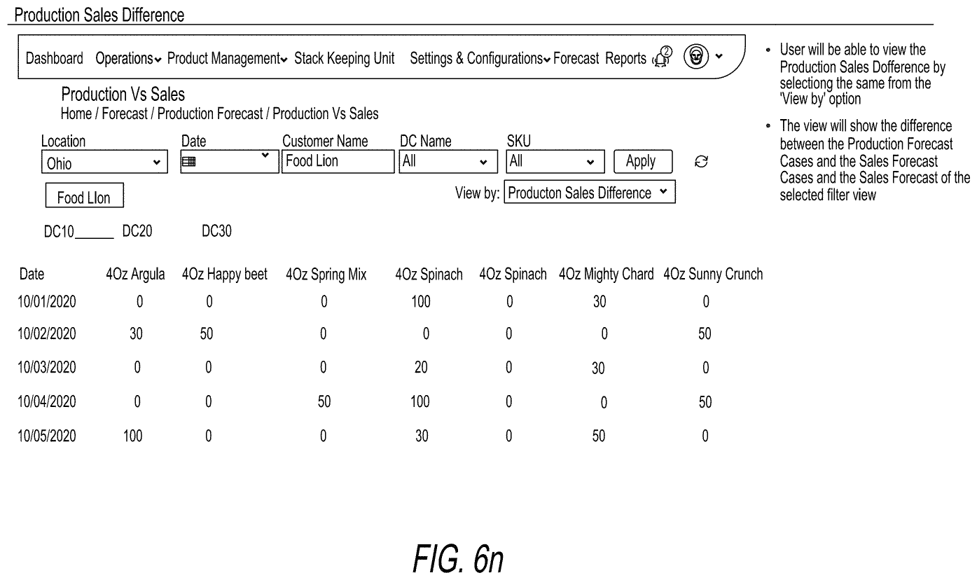

FIG. 6 is a block diagram of the utilization of forecasting and machine learning systems (see FIGS. 8 and 9) of the present disclosure used to operate the centralized planning and analytics system according to the present disclosure. That is, the centralized planning and analytics for greenhouse growing of hydroponic produce comprises: at least one greenhouse 101; an operations system 601; a forecasting system 104; a storage medium 135; a processor 115 which comprises at least a machine learning algorithm 801; and a network 130 which provides a communication pathway for information to move between at least two of the groups consisting of: greenhouse 101, operations system 601, growing system 603, forecasting system 104, storage medium 135 and processor 115.

Operations system 601 comprises: a seeding and germination system 503; a growing system and harvesting system 505; a logistics system 507; and an ordering and packaging system 501.

Growing system 505 determines how many germinated seeds disposed on a seeded board are to be transplanted onto a pond 552, wherein the growing system also determines the amount of fertilizer, the amount of carbon dioxide and/or adjustments to temperatures 556 that are required to meet predetermined growth targets, whereby the hydroponic produce is grown on each seeded board.

Forecasting system 104 comprises the steps of: generating crop analytics from an imaging system 807, wherein the crop analytics comprise: Analysis of climate above the crop (i.e., temperature, light level humidity etc.), climate below the crop (i.e., water temperature, pH, DO, etc.), germination and growth rate; generating climate trends from a climate module 809 disposed in each greenhouse 101; and using a machine learning algorithm 801 to determine yield forecast 803 of the hydroponic produce.

Processor 115 and storage medium 135 in FIG. 6 perform the following steps: stores forecast data to process at different stages of the platform.

Machine learning algorithm 801 performs the following calculations (determined yield forecast of the hydroponic produce) less (total oz/board by variety), thereby improving the overall fulfillment by matching supply with demand.

FIGS. 6a-o are production forecast, harvest, and sales charts according to the present disclosure. The production forecast chart shows harvest forecast lbs. by variety which is used to identify supply vs. demand. Growers enter yield prediction by entering Oz/Board and board count. The system then converts it into harvest forecast lbs.

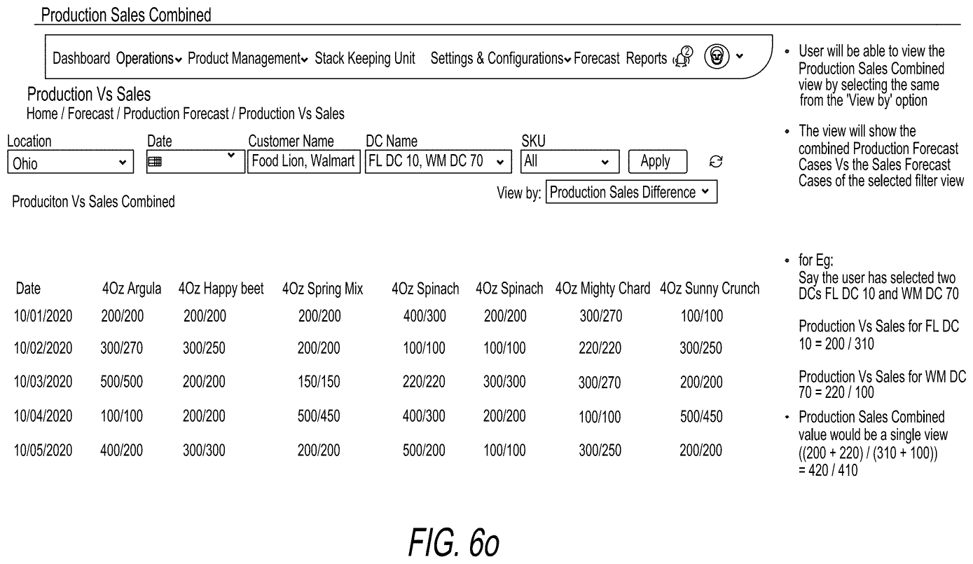

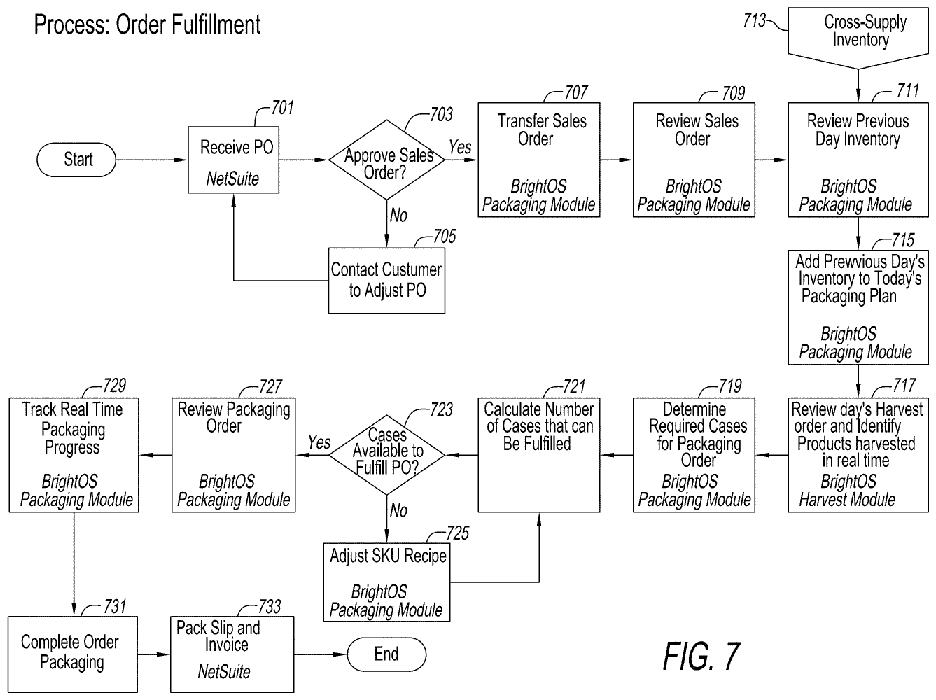

FIG. 7 is a logic diagram pertaining to the order fulfillment of the seed-to-ship backbone of FIG. 1, above, wherein a purchase order is received from NetSuite 701 and then the system determines whether or not the purchase or sales order is accepted or rejected 703. If rejected, then the customer is contacted to adjust the purchase order 705 and returned to step 701. If accepted, the sales order is then transferred to the packaging module 707, wherein the sales order is then reviewed 709. The system then reviews the previous day's inventory 711 and determines if the system requires cross-supply inventory 713 from other greenhouses 101 to meet the combination 715 of the previous day's inventory 711 and today's packaging plan 709.

Thereafter, the system reviews the day's harvest order and identifies products harvested in real time 717. The system then determines the required number of cases of product required for meeting the packaging order 719, and then calculates the number of cases that can be fulfilled 721 based upon amount of inventory 715 and the day's harvest 717. The system then determines if there are sufficient cases available to fulfill the purchase order 723. If no, then the system adjusts the SKU recipe 725 and recalculates the number of cases that can be fulfilled 721. If there are enough cases to fulfill the purchase order 723, then the system review the packaging order 727, tracks the real time packaging progress 729, completes the order packaging 731, and generates a packaging slip and invoice 733.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A system for centralized planning and analytics for greenhouse growing of hydroponic produce, the system comprising:
at least one greenhouse;
a purchasing system;
a forecasting system;
a storage medium;
a processor; and
a network which provides a communication pathway for information to move between at least two from the group consisting of: the greenhouse, the purchasing system, the accounting system, the forecasting system, the storage medium and the processor,
wherein the processor:
(a) receives digital inputs from the forecasting system;
(b) collects operations data to track seed to ship daily activities, wherein the operations data is at least one selected from the group consisting of: seeding, harvesting, collecting climate data, logistics and supply chain data, thereby determining how much of the hydroponic produce was harvested and packed to fulfill daily orders;
(c) analyzes demand and supply forecasts from the forecasting system and provides detailed output on future customer fulfillment;
(d) calculates the customer fulfillment based on customer priority; and
(e) integrates the operations data and combines the operations data with data collected from any of the at least one greenhouse, the purchasing system, and the forecasting system.

2. The system according to claim 1, wherein the purchasing system:
receives a purchase order from a customer; and
transmits the purchase order to a packaging system,
wherein the packaging system:
reviews the purchases order to determine packaging need by the customer and an associated stock-keeping unit (SKU);
reviews an inventory from a previous day and determines if a cross-supply inventory from another greenhouse is required to fulfill the purchase order;
adds the previous day's inventory to a current day's packaging plan;
reviews a harvest order from the current day and identifies if the hydroponic produce will be harvested in real time;
determines a number of cases required for packaging of the purchase order;
calculates a number of the cases that can be fulfilled based upon the previous day's inventory and the cross-supply inventory;
if there is not sufficient inventory to fulfill the purchase order, adjusts the number of cases that can be fulfilled and advise the customer of a shortage; and
if there is sufficient inventory to fulfill the purchase order, tracks real time packaging progress until packaging is completed and an invoice is generated.

3. The system according to claim 1, wherein the forecasting system:
generates crop analytics from an imaging system, wherein the crop analytics comprises crop health and growth data;
generates climate trends from a climate module, wherein there is one climate module in each of the at least one greenhouse; and
uses a machine learning algorithm to determine a yield forecast of the hydroponic produce.

4. The system according to claim 3, wherein the yield forecast is based upon at least one value selected from the group consisting of: ounces of the hydroponic produce per board, and board count.

5. The system according to claim 4, wherein the system calculates the total supply of the yield forecast against projected demand forecast of the variety of the hydroponic produce.

6. The system according to claim 5, wherein the forecasting system determines if there is a shortage or excess of any the variety of the hydroponic produce.

7. The system according to claim 6, wherein if the system determines that there is no shortage or excess of a particular the variety of the hydroponic produce, then the system creates seed, transplant, and harvest plan by day, and tracks real-time seed, transplant and harvesting processes.

8. The system according to claim 7, wherein if the system determines that there is a shortage or excess of a particular the variety of the hydroponic produce, then the system reforecasts by adjusting a map for a pond, wherein the pond is where the produce is grown.

9. The system according to claim 8, wherein if the system determines that the reforecasting by adjusting the pond map solved the excess or shortage issue, then the system returns to the step of adding to the yield forecast based upon at least one value selected from the group consisting of: ounces of the hydroponic produce per board, board count, and combinations thereof, and if the system determines that the reforecasting by adjusting the pond map did not solve the excess or shortage issue, then it requests a cross-supply from at least one other greenhouse.

10. The system according to claim 9, wherein if the cross-supply request is accepted by the at least one other greenhouse, then the system adds the cross-supply amount to the inventory of a particular the variety of the hydroponic produce, and if the cross-supply is not accepted by the at least one other greenhouse, then the system contacts a customer about the shortage.

11. The system according to claim 3, wherein data from the climate, the pond metrics and the yield are added to the machine learning algorithm which determines the yield forecast based on the data.

12. A system for centralized planning and analytics for greenhouse growing of hydroponic produce, the system comprising:
a plurality of greenhouses;
an imaging system;
a plurality of climate modules, with one of the plurality of climate modules in each of the plurality of greenhouses;
a forecasting system;
a storage medium;
a processor that comprises at least a machine learning algorithm thereon; and
a network that provides a communication pathway for information to move between at least two of the group consisting of: the greenhouses, the imaging system, the climate modules, the storage medium and the processor.

13. The system according to claim 12, wherein the forecasting system:
generates crop analytics from the imaging system;
generates climate trends from the climate module; disposed in each the at least one greenhouse; and
uses the machine learning algorithm to determine a yield forecast of the hydroponic produce.

14. The system of claim 1, further comprising
an operations system, wherein the operations system comprises:
a seeding system;
a germination system;
a growing system;
a harvesting system;
a logistics system; and
an ordering and packaging system.

15. The system according to claim 14, wherein the growing system determines how many germinated seeds disposed on a seeded board are to be transplanted onto a pond, wherein the growing system also determines an amount of fertilizer, an amount of carbon dioxide and/or adjustments to temperatures required to meet predetermined growth targets, whereby the hydroponic produce is grown on the seeded board.

16. The system according to claim 1, wherein the processor and the storage medium: calculate plant growth related calculations selected from the group consisting of: fertilization use, climate parameters, pond metrics, and combinations thereof; and provide yield forecast and actual output.

17. A method of centralized planning and analytics for greenhouse growing of hydroponic produce, the method comprising:
receiving a purchase order from a customer;
transmitting the purchase order to a packaging system, wherein the packaging system performs the following steps:
reviewing the purchase order to determine a packaging need by the customer and associated stock-keeping unit(s) (SKU);
reviewing the inventory of a day before the current day on which the purchase order is received, and determining if cross-supply inventory from other greenhouses is required to fulfill the purchase order;
adding the previous day's inventory to the current day's packaging plan;
reviewing a harvest order from the current day and identifying if the hydroponic produce will be harvested in real time;
determining a number of the required cases for packaging of the purchase order;
calculating the number of the cases that can be fulfilled based upon the previous day's inventory and the cross-supply inventory;
if there is not sufficient inventory to fulfill the purchase order, then adjusting the number of cases that can be fulfilled and advise the customer of any shortage; and
if there is sufficient inventory to fulfill the purchase order, then tracking real time packaging progress until packaging is completed and invoice is generated.

18. The method according to claim 17, further comprising forecasting a yield of hydroponic produce comprising the steps of:
generating crop analytics from an imaging system, wherein the crop analytics comprises provides crop health and growth data, germination rate, growth rate by crop, and microclimate;
generating climate trends from a climate module disposed in each the at least one greenhouse; and
using a machine learning algorithm to determine yield forecast of the hydroponic produce.

19. The method of claim 17, further comprising the steps of:
depositing a predetermined amount of a media onto a board such that a plurality of furrows are formed within the media, and depositing the seeds within the furrows to form a seeded board;
transferring the seeded board to a germination room for a period of time to enable germination of the seeds disposed thereon;
determining how many germinated seeds disposed on the seeded board are to be transplanted onto a pond;
determining the amount of fertilizer, the amount of carbon dioxide and/or adjustments to temperatures required to meet predetermined growth targets, whereby the hydroponic produce is grown on the seeded board;
calculating a daily harvest plan for the hydroponic produce based on the purchase order and pulling sufficient number of seeded boards to meet the daily harvest plan.

20. The method according to claim 19, further comprising the steps of:
identifying a number of logistics truck(s) needed for delivering to a customer based on receiving a purchase order;
determining the packaging need by the customer and the associated stock-keeping unit(s) (SKU); and
tracking cross-supply inventory request(s) and approval which is used by the logistics system to schedule and transport the hydroponic produce to the customer.
